(19) United States
(12) Patent Application Publication
(10) Pub. No.: US 2012/0092595 A1
(43) Pub. Date: Apr. 19, 2012

(54) Optical film, polarizing plate and liquid crystal display device

(75) Inventors: Yoshiaki Hisakado, Kanagawa (JP); Yoji Ito, Kanagawa (JP)

(73) Assignee: FUJIFILM Corporation, Tokyo (JP)

(21) Appl. No.: 13/317,111

(22) Filed: Oct. 11, 2011

(30) Foreign Application Priority Data
Oct. 13, 2010 (JP) 2010-231032

(51) Int. Cl. G02F 1/1335; G02B 5/30

(52) U.S. Cl. 349/96; 359/489.07; 359/486.01

(57) ABSTRACT

An optical film is provided and includes: a transparent support satisfying the following expressions (1) and (2); and an optically anisotropic layer having a λ/4 function. The optical film has an Rth (550) satisfying a relation of |Rth (550)|≦20.

|Re (550)|≦10 (1)

|ΔRth (25° C. 30% RH−25° C80% RH)|≦20 (2)

Re (550) represents an in-plane retardation Re at a wavelength of 550 nm, and Rth (550) represents a retardation Rth in a film thickness direction at a wavelength of 550 nm; and ΔRth (25° C. 30% RH−25° C. 80% RH) represents a difference between Rth (550) at 25° C. and 30% RH and Rth (550) at 25° C. and 80% RH

This application is based on and claims priority under 35 U.S.C. §119 from Japanese Patent Application No. 2010-231032, filed Oct. 13, 2010, the entire disclosure of which is herein incorporated by reference.

### BACKGROUND OF THE INVENTION

1. Field of the Invention

The present invention relates to an optical film, and in particular, to an optical film which is suitably used for 3D (stereoscopic image or three-dimensional image) displays. Also, the invention relates to a polarizing plate and a liquid crystal display device each using the optical film.

2. Background Art

Retardation plates including a λ/4 plate have very many applications and are already used for reflection type liquid crystal display devices, semi-transmission type liquid crystal display devices, luminance enhancing films, pickups for optical disk systems, or PS conversion elements. The majority of retardation plates which are currently used therefor are a retardation plate in which optical anisotropy is revealed by stretching a polymer film. However, in polymer films, since it is difficult to precisely control the optical anisotropy, there are proposed retardation plates in which an optically anisotropic layer obtained by aligning a discotic liquid crystalline compound or a rod-shaped compound in a prescribed direction and fixing it is formed in a polymer film form (see JP-A-2004-53841, JP-A-9-292522, JP-A-2007-108732).

Furthermore, as an application of retardation plates, there is also proposed a configuration in which the retardation plate is used for a forefront surface of an organic EL, a touch panel, a 3D display, etc. However, retardation plates in the background art involved such problems that they are easily scratched; that they are insufficient in strength, high in reflection intensity of external light and weak in heat resistance, humidity resistance, light resistance, etc.; and that they are easily stained and difficult to get the stains out. Therefore, such retardation plates in the background art were not suitable for use for a forefront surface.

Now, the 3D display can be roughly classified into two systems of (1) a glass system and (2) a naked-eye system. In the glass system (1), an image for a right eye and an image for a left eye are alternately displayed in a time division manner by a usual 2D display, and the image for a left eye and the image for a right eye are composited by a pair of glasses having a polarizing plate disposed therein, thereby synthesizing a 3D (stereoscopic image or three-dimensional image) display in a human brain in a pseudo manner. On the other hand, in the naked-eye system (2), an image for a right eye and an image for a left eye are simultaneously displayed by a 2D display, and the images are composited in a geometrical optics manner using an optical member such as a lens and a slit, thereby making one to recognize a 3D image.

The glass system (1) can be classified into (i) a polarized glass system and (ii) a shutter glass system. In the polarized glass system (i), not only a right eye image and a left eye image are alternately displayed in every line in the vertical direction, but the right eye image and the left eye image are alternately displayed solely in a time division manner, on a 2D display. As a system for alternately displaying a right eye image and a left eye image in every line, there is proposed a system in which a patterning retardation film disposed by crossing the slow axis direction of a λ/4 retardation film at 90° on a polarizing plate is provided on a viewing-side polarizing plate of a liquid crystal display device (see JP-A-2005-215326, US 2005/0168816, and US 2008/0239484). Also, as the shutter glass system (ii), there is proposed a system in which a right eye image and a left eye image are alternately displayed in a time division manner on a 2D display, and when the right eye image is displayed, the left eye of the pair of glasses equipped with a shutter is turned off and intercepted, thereby enabling one to recognize only the right eye image (see JP-A-10-23464).

### SUMMARY OF THE INVENTION

In the 3D display of the glass system (1) which is becoming the mainstream at present, since a protective film disposed between a viewing-side polarizing plate in a liquid crystal display device and a polarizing plate formed on a pair of glasses has a retardation, at the time of seeing obliquely while inclining a human head, a crosstalk of 3D images (ghost of images) or a flicker due to reflection of external light is generated. Also, in the case of the polarized glass system (i), a crosstalk is also generated in view of the fact that in a patterning retardation film to be provided on a viewing-side polarizing plate, an optical performance or size changes due to a change in humidity or temperature, or the like.

Under the foregoing circumstances, an object of the invention is to provide an optical film which can be fabricated with high productivity, has a performance such that it can be used for a forefront surface of a display, and is excellent in reducing a crosstalk of a 3D display. Furthermore, another object of the invention is to provide a polarizing plate and a liquid crystal display device each using the optical film.

As a result of investigations made by the present inventors, it has been found that it is effective for reducing a crosstalk or flicker to impart a λ/4 function to a viewing-side surface of a viewing-side polarizing plate in a 3D liquid crystal display device. Furthermore, it has been found that when an optical film having an optically anisotropic layer having a λ/4 function on a transparent support having a specified retardation and having a small humidity change of the retardation is provided on a viewing-side surface, a 3D liquid crystal display device which is excellent in a display performance and exhibits broad color reproducibility at a high viewing angle and in which the display performance is not deteriorated even by circumferential changes of humidity, etc. is obtained. Since the optically anisotropic layer having a λ/4 function in the invention is free from a change of retardation by the humidity, by suppressing a humidity change of retardation of the transparent support, the change of retardation of the whole of the optical film by the humidity can be suppressed. It has been found that in order to suppress the humidity change of retardation of the transparent support, it is preferable to use a cellulose acylate having a specified substituent structure, or to add a specified plasticizer.

That is, the foregoing objects can be achieved by the following means.
[1] An optical film comprising: a transparent support satisfying the following expressions (1) and (2); and an optically anisotropic layer having a λ/4 function,

wherein

the optical film has an Rth (550) satisfying a relation of |Rth (550)|≦20:

|Re(550)|≦10 (1)

|ΔRth(25° C. 30% RH−25° C. 80% RH)|≦20 (2)

wherein

Re (550) represents an in-plane retardation Re at a wavelength of 550 nm, and Rth (550) represents a retardation Rth in a film thickness direction at a wavelength of 550 nm; and

ΔRth (25° C. 30% RH−25° C. 80% RH) represents a difference between Rth (550) at 25° C. and 30% RH and Rth (550) at 25° C. and 80% RH,

wherein

the in-plane retardation Re and the retardation Rth in the film thickness direction are defined relative to a layer having a film thickness d according to the following expressions:

R=(nx−ny)×d

Rth=((nx+ny)/2−nz)×d

wherein

nx represents a refractive index in a slow axis direction in a plane of the layer; ny represents a refractive index in ae direction orthogonal to nx in the plane; and nz represents a refractive index in the film thickness direction orthogonal to nx and ny.
[2] The optical film according to [1], wherein the Rth (550) of the transparent support is smaller than 0.
[3] The optical film according to [1] or [2], wherein the transparent support has a linear thermal expansion coefficient of 65 ppm/° C. or less.
[4] The optical film according to any one of [1] to [3], wherein the transparent support contains a cellulose acylate.
[5] The optical film according to [4], wherein the cellulose acylate has an aromatic group-containing acyl group.
[6] The optically film according to [4] or [5], wherein the transparent support contains a polymer plasticizer in a content of 30% by mass or more relative to the cellulose acylate, the polymer plasticizer having a number average molecular weight of from 500 to 10,000 and having a repeating unit including a dicarboxylic acid and a diol
[7] A polarizing plate comprising: a polarizer, and a protective layer, wherein the protective film is an optical film according to any one of [1] to [6].
[8] The polarizing plate according to [7], wherein the optically anisotropic layer is a patterning retardation layer including a plurality of regions, wherein directions of slow axes of the regions are different from each other.
[9] A liquid crystal display device comprising a polarizing plate according to [7] or [8].
[10] A liquid crystal display device comprising:

a pair of substrates disposed opposing to each other, at least one of which has an electrode;

a liquid crystal layer between the pair of substrates; and

a first polarizing plate and a second polarizing plate interposing the liquid crystal sell, the first polarizing plate being disposed on a light source side, the second polarizing plate being disposed on a viewing side, each of the first and second polarizing plates having a polarizer and a protective film at least on an outer side surface of the polarizer,

with an image being viewed through a third polarizing plate existing on the viewing side of the second polarizing plate and having a polarizer and at least one protective film,

wherein

the protective film on the viewing side of the second polarizing plate is an optical film according to any one of [1] to [6].

### BRIEF DESCRIPTION OF THE DRAWING

FIG. 1 is a view schematically showing a configuration of an exemplary embodiment of a liquid crystal display device of the invention.

FIG. 2 is a diagrammatic view showing an example of a pixel region of an IPS mode liquid crystal cell fabricated in the Example.

### DETAILED DESCRIPTION OF THE INVENTION

According to an exemplary embodiment of the invention, it is possible to provide an optical film which can be fabricated with high productivity, has a performance such that it can be used for a forefront surface of a display, and is excellent in reducing a crosstalk of a 3D display. Furthermore, it is possible to provide a 3D displayer which is small in viewing angle dependency and excellent in durability, with good productivity.

Exemplary embodiments of the invention is hereunder described in detail.

Incidentally, in this specification, a numerical range expressed by the terms “a number to another number” means a range falling between the former number indicating a lower limit value of the range and the latter number indicating an upper limit value thereof.

In this specification, the terms “parallel” and “orthogonal” mean that the designated angle falls within the range of less than ±10° from a strict angle. This range is preferably less than ±5°, and more preferably less than ±2° in terms of an error from the strict angle. Also, the terms “substantially vertical” mean that the designated angle falls within the range of less than ±20° from a strict angle. This range is preferably less than ±15°, and more preferably less than ±10° in terms of an error from the strict angle.

Also, the “slow axis” means a direction at which the refractive index is maximum. Furthermore, a measurement wavelength of the refractive index is a value at λ=550 nm of a visible light region unless otherwise indicated.

In this specification, the terms “polarizing plate” are used in a sense so as to include both a longitudinal polarizing plate and a polarizing plate cut into a size to be incorporated into a liquid crystal display device (in this specification, the term “cutting” includes “punching”, “cutting out”, etc.) unless otherwise indicated. Also, in this specification, though the “polarizer” and the “polarizing plate” are used so as to be distinguished from each other, the “polarizing plate” means a stack having on at least one surface of a “polarizer” a protective film for protecting the polarizer.

### <Optical Film (Stacked Film)>

An optical film according to an exemplary embodiment of the invention includes a transparent support satisfying the following expressions (1) and (2) and an optically anisotropic layer having a λ/4 function, wherein an Rth (550) of the optical film satisfies a relation of |Rth (550)|≦20.

|Re(550)|≦10 (1)

|ΔRth(25° C. 30% RH−25° C. 80% RH)|≦20 (2)

Re (550) represents an in-plane retardation Re at a wavelength of 550 nm, and Rth (550) represents a retardation Rth in the film thickness direction at a wavelength of 550 nm.

ΔRth (25° C. 30% RH−25° C. 80% RH) represents a difference between Rth (550) at 25° C. and 30% RH and Rth (550) at 25° C. and 80% RH.

The in-plane retardation Re and the retardation Rth in the film thickness direction are defined relative to a layer having a film thickness d according to the following expressions.

Re=(nx−ny)×d

Rth=((nx+ny)/2−nz)×d

In the foregoing expressions, nx represents a refractive index in the slow axis direction in the plane of the layer; ny represents a refractive index in the direction orthogonal to nx in the plane; and nz represents a refractive index in the film thickness direction orthogonal to nx and ny.

As to an application of the optical film of the invention to a liquid crystal display device, there are included the case where the optical film is disposed between either one or both of a first polarizing plate (light source-side polarizing plate) and a second polarizing plate (viewing-side polarizing plate) to be disposed on the both sides of a liquid crystal layer (liquid crystal cell) of the liquid crystal display device, and the liquid crystal layer; and the case where the optical film is disposed on a viewing-side uppermost surface of the viewing-side second polarizing plate. In all of these cases, the optical film is able to also serve as a protective film.

In the optical film of the invention, the optically anisotropic layer having a λ/4 function (hereinafter also referred to as “λ/4 layer”) can be formed entirely or formed upon patterning on the transparent support.

In the optical film of the invention, for the purpose of obtaining an excellent performance at any viewing angle, a retardation between the transparent support and the λ/4 layer is adjusted. Specifically, the retardation in the film thickness direction is adjusted at substantially 0 as |Rth|≦20. What the retardation in the film thickness direction is adjusted at substantially 0 means that the retardation is approximately equal in seeing from any angle (polar angle). Accordingly, at the time when polarized light passes through this film, even when the polarized light passes at any angle (polar angle), its amount of change becomes approximately equal, and therefore, a substantially identical polarization state is presented. Accordingly, it is possible to make a difference between observation from the front and observation from the oblique direction small, and it is possible to minimize the viewing angle dependency.

Also, though the foregoing is concerned with the case of a single layer of λ/4 layer, even in a film obtained by further stacking other layer than the λ/4 layer, by adjusting the retardation in the film thickness direction as a whole at substantially 0, the same effects are obtained. As a matter of course, strictly speaking, from the viewpoint of asymmetry, the amount of change is slightly different; however, when designing is made while taking into consideration this matter, the foregoing explanation is not overturned.

As a representative method of forming the λ/4 layer on the transparent support, there are the following four systems according to a combination of an alignment state of a liquid crystalline compound of the λ/4 layer and an optical performance of the transparent support. Here, the horizontal direction means an in-plane direction, and the vertical direction means a film thickness direction.

TABLE 1

| λ/4 layer | Transparent support |
|---|---|
| Rod-shaped liquid crystalline com- | Positive C plate |
| pound, as horizontally aligned | |
| Rod-shaped liquid crystalline com- | Positive A plate or biaxial film |
| pound, as vertically aligned | |
| Discotic liquid crystalline compound, | Biaxial film |
| as horizontally aligned | |
| Discotic liquid crystalline compound, | Negative C plate or low retardation |
| as vertically aligned | film (\|Re\| < 10, \|Rth\| < 10 nm) |

### <Transparent Support>

As a transparent support of the optical film of the invention, it is desirable to use a film which is substantially free from an in-plane retardation (Re).

The in-plane retardation (frontal retardation value) of the transparent support of the optical film of the invention satisfies the following (1) and (2).

|Re(550)|≦10 (1)

|ΔRth(25° C. 30% RH−25° C. 80% RH)|≦20 (2)

Here, Re (550) represents a in-plane retardation Re at a wavelength of 550 nm, and Rth (550) represents a retardation Rth in the film thickness direction at a wavelength of 550 nm.

ΔRth (25° C. 30% RH−25° C. 80% RH) represents a difference between Rth (550) at 25° C. and 30% RH and Rth (550) at 25° C. and 80% RH.

### <Material Quality of Transparent Support>

As a material for forming the transparent support of the invention, polymers which are excellent in optical performance, transparency, mechanical strength, heat stability, moisture blocking properties, isotropy, and the like are preferable; and any material is useful so far as it satisfies the foregoing expressions (1) and (2) with regards to Re and Rth, and it satisfies a relation of |Rth (550)|≦20 as a whole of the optical film. Examples thereof include polycarbonate based polymers; polyester based polymers such as polyethylene terephthalate and polyethylene naphthalate; acrylic polymers such as polymethyl methacrylate; and styrene based polymers such as polystyrene and a acrylonitrile-styrene copolymer (AS resin). Also, the examples includes polyolefins such as polyethylene and polypropylene; polyolefin base polymers such as an ethylene-propylene copolymer; vinyl chloride based polymers; amide based polymers such as nylons and aromatic polyamides; imide based polymers; sulfone based polymers; polyether sulfone based polymers; polyetheretherketone based polymers; polyphenylene sulfide based polymers; vinylidene chloride based polymers; vinyl alcohol based polymers; vinyl butyral based polymers; allylate based polymers; polyoxymethylene based polymers; epoxy based polymers; and mixed polymers of the foregoing polymers. Also, the polymer film of the invention can be formed as a cured layer of an ultraviolet ray-curable or thermosetting resin such as acrylic, urethane based, acrylic urethane based, epoxy based or silicone based resins.

Also, as the material for forming the transparent support of the invention, a thermoplastic norbornene based resin can be preferably used. Examples of the thermoplastic norbornene based resin include ZEONEX and ZEONOR, both of which are manufactured by Zeon Corporation; and ARTON, manufactured by JSR Corporation.

Also, as the material for forming the transparent support of the invention, a cellulose based polymer (hereinafter referred to as “cellulose acylate”) represented by triacetyl cellulose which has hitherto been used as a protective film of a polarizing plate can be preferably used.

While the cellulose acylate is hereunder chiefly described in detail as an example of the transparent support of the invention, it will be apparent that its technical matters are similarly applicable to other polymer films.

### <Raw Material Cotton of Cellulose Acylate>

Examples of the cellulose as a raw material of the cellulose acylate which is used in the invention include cotton linter and wood pulps (for example, hardwood pulps, soft wood pulps, etc.), and cellulose acylates obtained from any of these raw material celluloses can be used. As the case may be, a mixture thereof may be used. These raw material celluloses are described in detail in, for example, Course of Plastic Materials (17): Cellulose Resins (written by Marusawa and Uda and published by The Nikkan Kogyo Shimbun, Ltd. (1970)); and Journal of Technical Disclosure, No. 2001-1745 (pages 7 to 8) by Japan Institute of Invention and Innovation. But, it should be construed that the cellulose acylate to be used for the cellulose acylate film is not particularly limited thereto.

### <Degree of Substitution of Cellulose Acylate>

Next, the cellulose acylate of the invention which is manufactured using the foregoing cellulose as a raw material is described. The cellulose acylate of the invention is one obtained by acylating the hydroxyl groups of cellulose, and any acyl groups including from an acetyl group having two carbon atoms to one having 22 carbon atoms can be used as a substituent thereof. In the cellulose acylate of the invention, the degree of substitution on the hydroxyl groups of the cellulose is not particularly limited. However, the degree of substation can be obtained by measuring a degree of bonding of acetic acid and/or a fatty acid having from 3 to 22 carbon atoms which substitutes on the hydroxyl groups of the cellulose. The measurement method can be carried out in accordance with ASTM D-817-91.

In the cellulose acylate of the invention, the degree of substitution on the hydroxyl groups of the cellulose is not particularly limited. However, the degree of acyl substitution on the hydroxyl groups of the cellulose is desirably from 2.50 to 3.00. The degree of substitution is more desirably from 2.75 to 3.00, and still more desirably from 2.85 to 3.00.

Of acetic acid and/or a fatty acid having from 3 to 22 carbon atoms which substitutes on the hydroxyl groups of the cellulose, the acyl group having from 2 to 22 carbon atoms is not particularly limited and may be either an aliphatic group or an aromatic group, and it may be used solely or in admixture of two or more kinds thereof. Examples of the cellulose ester acylated therewith include alkyl carbonyl esters, alkenyl carbonyl esters, aromatic carbonyl esters or aromatic alkyl carbonyl esters of cellulose. Such an ester may further have a substituted group. As the preferred acyl group, there can be exemplified acetyl, propionyl, butanoyl, heptanoyl, hexanoyl, octanoyl, decanoyl, dodecanoyl, tridecanoyl, tetradecanoyl, hexadecanoyl, octadecanoyl, isobutanoyl, t-butanoyl, cyclohexanecarbonyl, oleoyl, benzoyl, naphthylcarbonyl, and cinnamoyl groups. Of these, acetyl, propionyl, butanoyl, dodecanoyl, octadecanoyl, t-butanoyl, oleoyl, benzoyl, naphthylcarbonyl, or cinnamoyl is preferable, and acetyl, propionyl, or butanoyl is more preferable.

As a result of extensive and intensive investigations made by the present inventors, it has been noted that of the foregoing acyl substituents which substitute on the hydroxyl groups of the cellulose, in the case where the acyl substituent is substantially composed of at least one member of an acetyl group, a propionyl group and a butanoyl group, when its degree of substitution is from 2.50 to 3.00, the optical anisotropy of the cellulose acylate film can be lowered. The degree of acyl substitution is preferably from 2.60 to 3.00, and more preferably from 2.65 to 3.00. Also, in the case where the acyl substituent which substitutes on the hydroxyl groups of the cellulose is composed of only an acetyl group, in additive to the matter that the optical anisotropy of the film can be lowered, from the viewpoint of compatibility with additives and solubility in an organic solvent to be used, the degree of substitution is preferably from 2.80 to 2.99, and more preferably from 2.85 to 2.95.

From the standpoint of reducing the optical anisotropy of the film or suppressing a change in performance to be caused due to a change in temperature and relative humidity, a compound having an aromatic group-containing acyl group (substituent A) and an aliphatic acyl group (substituent B) is also preferable as the cellulose acylate.

### <Aromatic Group-Containing Acyl Group (Substituent A)>

The substituent A is an aromatic group-containing acyl group. A connecting group may be present between the acyl group and the aromatic group. The connecting group is preferably an alkylene group, an alkenylene group, or an alkynylene group each having from 1 to 10 carbon atoms; more preferably an alkylene group or an alkenylene group each having from 1 to 6 carbon atoms; and still more preferably an alkylene group or an alkenylene group each having from 1 to 4 carbon atoms. However, it is preferable that the acyl group and the aromatic group are bonded directly to each other, namely, it is preferable that the substituent A is a substituent represented by Ar—C(═O)— (wherein Ar represents a substituted or unsubstituted aryl group). The substituent A is a substituent having a polarizability anisotropy due to the presence of the aromatic group. The polarizability anisotropy Act is defined according to the following expression.

Δα=αₓ−(α_{y}+α₂)/2

In the foregoing expression, αₓ is the largest component of characteristic values obtained after diagonalization of polarizability tensor; α_{y} is the second largest component of characteristic values obtained after diagonalization of polarizability tensor; and α_{z} is the smallest component of characteristic values obtained after diagonalization of polarizability tensor.

In the invention, the polarizability of the substituent A is preferably 2.5×10⁻²⁴ cm³. Incidentally, the polarizability anisotropy of the substituent can be specifically calculated by using Gaussian 03 (Revision B. 03, a software manufactured by U.S. Gaussian Corporation). Specifically, the polarizability is calculated with B3LYP/6-311+G** level by using the structure of the substituent after being optimized at the B3LYP/6-31G* level. Then, the obtained polarizability tensor is diagonalized, and a diagonal component is used to calculate the polarizability anisotropy.

The term “aromatic” is defined as an aromatic compound” on page 1208 of Rikagakujiten (Dictionary of Physics and Chemistry), Fourth Edition (Iwanami Shoten, Publishers), and the aromatic group in the invention may be any of an aromatic hydrocarbon group or an aromatic heterocyclic group and is more preferably an aromatic hydrocarbon group.

The aromatic hydrocarbon group is preferably one having from 6 to 24 carbon atoms, more preferably one having from 6 to 12 carbon atoms, and still more preferably one having from 6 to 10 carbon atoms. Specific examples of the aromatic hydrocarbon group include a phenyl group, a naphthyl group, an anthryl group, a biphenyl group, and a terphenyl group, with a phenyl group being more preferable. As the aromatic hydrocarbon group, a phenyl group, a naphthyl group, or a biphenyl group is especially preferable. As the aromatic heterocyclic group, one containing at least one of an oxygen atom, a nitrogen atom, and a sulfur atom is preferable. Examples of the heterocycle thereof include furan, pyrrole, thiophene, imidazole, pyrazole, pyridine, pyrazine, pyridazine, triazole, triazine, indole, indazole, purine, thiazoline, thiadiazole, oxazoline, oxazole, oxadiazole, quinoline, isoquinoline, phthalazine, naphthylizine, quinoxaline, quinazoline, cinnoline, pteridine, acridine, phenanthoroline, phenazine, tetrazole, benzimidazole, benzoxazole, benzthiazole, benzotriazole, and tetrazaindene. As the aromatic heterocyclic ring group, a pyridyl group, a triazinyl group, or a quinolyl group is especially preferable.

Such an aromatic ring may have a substituent.

Preferred examples of the substituent A include a phenylacetyl group, a hydrocinnamoyl group, a diphenylacetyl group, a phenoxyacetyl group, a benzyloxyacetyl group, an O-acetylmandelyl group, a 3-methoxyphenylacetyl group, a 4-methoxyphenylacetyl group, a 2,5-dimethoxyphenylacetyl group, a 3,4-dimethoxyphenylacetyl group, a 9-fluorenylmethylacetyl group, a cinnamoyl group, a 4-methoxy-cinnamoyl group, a benzoyl group, an ortho-toluoyl group, a meta-toluoyl group, a para-toluoyl group, an m-anisoyl group, a p-anisoyl group, a phenylbenzoyl group, a 4-ethylbenzoyl group, a 4-propylbenzoyl group, a 4-tert-butylbenzoyl group, a 4-butylbenzoyl group, a 4-pentylbenzoyl group, a 4-hexylbenzoyl group, a 4-heptylbenzoyl group, a 4-octylbenzoyl group, a 4-vinylbenzoyl group, a 4-ethoxybenzoyl group, a 4-butoxybenzoyl group, a 4-hexyloxybenzoyl group, a 4-heptyloxybenzoyl group, a 4-pentyloxybenzoyl group, a 4-octyloxybenzoyl group, a 4-nonyloxybenzoyl group, a 4-decyloxybenzoyl group, a 4-undecyloxybenzoyl group, a 4-dodecyloxybenzoyl group, a 4-isopropioxybenzoyl group, a 2,3-dimethoxybenzoyl group, a 2,5-dimethoxybenzoyl group, a 3,4-dimethoxybenzoyl group, a 2,6-dimethoxybenzoyl group, a 2,4-dimethoxybenzoyl group, a 3,5-dimethoxybenzoyl group, a 3,4,5-trimethoxybenzoyl group, a 2,4,5-trimethoxybenzoyl group, a 1-naphthoyl group, a 2-naphthoyl group, a 2-biphenylcarbonyl group, a 4-biphenylcarbonyl group, a 4′-ethyl-4-biphenylcarbonyl group, a 4′-octyloxy-4-biphenylcarbonyl group, a piperonyloyl group, a diphenylacetyl group, a triphenylacetyl group, a phenylpropionyl group, a hydrocinnamoyl group, an α-methylhydrocinnamoyl group, a 2,2-diphenylpropionyl group, a 3,3-diphenylpropionyl group, a 3,3,3-triphenylpropionyl group, a 2-phenylbutyryl group, a 3-phenylbutyryl group, a 4-phenylbutyryl group, a 5-phenylvaleryl group, a 3-methyl-2-phenylvaleryl group, a 6-phenylhexanoyl group, an a-methoxyphenylacetyl group, a phenoxyacetyl group, a 3-phenoxypropionyl group, a 2-phenoxypropionyl group, a 11-phenoxydecanoyl group, a 2-phenoxybutyryl group, a 2-methoxyacetyl group, a 3-(2-methoxyphenyl)propionyl group, a 3-(p-toluyl)propionyl group, a (4-methylphenoxy)acetyl group, a 4-isobutyl-α-methylphenylacetyl group, a 4-(4-methoxyphenyl)butyryl group, a (2,4-di-tert-pentylphenoxy)-acetyl group, a 4-(2,4-di-tert-pentylphenoxy)-butyryl group, a (3,4-dimethoxyphenyl)acetyl group, a 3,4-(methylenedioxy)phenylacetyl group, a 3-(3,4-dimethoxyphenyl)propionyl group, a 4-(3,4-dimethoxyphenyl)butyryl group, a (2,5-dimethoxyphenyl)acetyl group, a (3,5-dimethoxyphenyl)acetyl group, a 3,4,5-trimethoxyphenylacetyl group, a 3-(3,4,5-trimethoxyphenyl)-propionyl group, an acetyl group, a 1-naphthylacetyl group, a 2-naphthylacetyl group, an α-trityl-2-naphthalene-propionyl group, a (1-naphthoxy)acetyl group, a (2-naphthoxy)acetyl group, a 6-methoxy-α-methyl-2-naphthaleneacetyl group, a 9-fluoreneacetyl group, a 1-pyreneacetyl group, a 1-pyrenebutyryl group, a γ-oxo-pyrenebutyryl group, a styreneacetyl group, an α-methylcinnamoyl group, an α-phenylcinnamoyl group, a 2-methylcinnamoyl group, a 2-methoxycinnamoyl group, a 3-methoxycinnamoyl group, a 2,3-dimethoxycinnamoyl group, a 2,4-dimethoxycinnamoyl group, a 2,5-dimethoxycinnamoyl group, a 3,4-dimethoxycinnamoyl group, a 3,5-dimethoxycinnamoyl group, a 3,4-(methylenedioxy)cinnamoyl group, a 3,4,5-trimethoxycinnamoyl group, a 2,4,5-trimethoxycinnamoyl group, a 3-methylidene-2-carbonyl group, a 4-(2-cyclohexyloxy)benzoyl group, a 2,3-dimethylbenzoyl group, a 2,6-dimethylbenzoyl group, a 2,4-dimethylbenzoyl group, a 2,5-dimethylbenzoyl group, a 3-methoxy-4-methylbenzoyl group, a 3,4-diethoxybenzoyl group, an α-phenyl-O-toluyl group, a 2-phenoxybenzoyl group, a 2-benzoylbenzoyl group, a 3-benzoylbenzoyl group, a 4-benzoylbenzoyl group, a 2-ethoxy-l-naphthoyl group, a 9-fluorenecarbonyl group, a 1-fluorenecarbonyl group, a 4-fluorenecarbonyl group, a 9-anthracenecarbonyl group, and a 1-pyrenecarbonyl group.

More preferred examples of the substituent A include a phenylacetyl group, a hydrocinnamoyl group, a diphenylacetyl group, a phenoxyacetyl group, a benzyloxyacetyl group, an O-acetylmandelyl group, a 3-methoxyphenylacetyl group, a 4-methoxyphenylacetyl group, a 2,5-dimethoxyphenylacetyl group, a 3,4-dimethoxyphenylacetyl group, a 9-fluorenylmethylacetyl group, a cinnamoyl group, a 4-methoxy-cinnamoyl group, a benzoyl group, an ortho-toluoyl group, a meta-toluoyl group, a para-toluoyl group, an m-anisoyl group, a p-anisoyl group, a phenylbenzoyl group, a 4-ethylbenzoyl group, a 4-propylbenzoyl group, a 4-tert-butylbenzoyl group, a 4-butylbenzoyl group, a 4-pentylbenzoyl group, a 4-hexylbenzoyl group, a 4-heptylbenzoyl group, a 4-octylbenzoyl group, a 4-vinylbenzoyl group, a 4-ethoxybenzoyl group, a 4-butoxybenzoyl group, a 4-hexyloxybenzoyl group, a 4-heptyloxybenzoyl group, a 4-pentyloxybenzoyl group, a 4-octyloxybenzoyl group, a 4-nonyloxybenzoyl group, a 4-decyloxybenzoyl group, a 4-undecyloxybenzoyl group, a 4-dodecyloxybenzoyl group, a 4-isopropioxybenzoyl group, a 2,3-dimethoxybenzoyl group, a 2,5-dimethoxybenzoyl group, a 3,4-dimethoxybenzoyl group, a 2,6-dimethoxybenzoyl group, a 2,4-dimethoxybenzoyl group, a 3,5-dimethoxybenzoyl group, a 2,4,5-trimethoxybenzoyl group, a 3,4,5-trimethoxybenzoyl group, a 1-naphthoyl group, a 2-naphthoyl group, a 2-biphenylcarbonyl group, a 4-biphenylcarbonyl group, a 4′-ethyl-4-biphenylcarbonyl group, and a 4′-octyloxy-4-biphenylcarbonyl group.

Still more preferred examples of the substituent A include a phenylacetyl group, a diphenylacetyl group, a phenoxyacetyl group, a cinnamoyl group, a 4-methoxy-cinnamoyl group, a benzoyl group, a phenylbenzoyl group, a 4-ethylbenzoyl group, a 4-propylbenzoyl group, a 4-tert-butylbenzoyl group, a 4-butylbenzoyl group, a 4-pentylbenzoyl group, a 4-hexylbenzoyl group, a 4-heptylbenzoyl group, a 3,4-dimethoxybenzoyl group, a 2,6-dimethoxybenzoyl group, a 2,4-dimethoxybenzoyl group, a 3,5-dimethoxybenzoyl group, a 3,4,5-trimethoxybenzoyl group, a 2,4,5-trimethoxybenzoyl group, a 1-naphthoyl group, a 2-naphthoyl group, a 2-biphenylcarbonyl group, and a 4-biphenylcarbonyl group.

Yet still more preferred examples of the substituent A include a benzoyl group, a phenylbenzoyl group, a 4-heptylbenzoyl group, a 2,4,5-trimethoxybenzoyl group, and a 3,4,5-trimethoxybenzoyl group,

### <Aliphatic Acyl Group (Substituent B)>

The substituent B is an aliphatic acyl group and is a substituent represented by Al i-C(═O)— (wherein Ali represents a substituted or unsubstituted aliphatic group, provided that an aromatic group is not included as the substituent). The substituent B may be an aliphatic acyl group having any of a linear, branched or cyclic structure, and may be an acyl group of an unsaturated bond-containing aliphatic group. The aliphatic acyl group is preferably one having from 2 to 20 carbon atoms, more preferably one having from 2 to 10 carbon atoms, and still more preferably one having from 2 to 4 carbon atoms. Preferred examples of the substituent B include an acetyl group, a propionyl group, and a butyryl group. Of these, an acetyl group is preferable. When the cellulose acylate has the substituent B having a small number of carbon atoms, such as an acetyl group, an appropriate strength as the film can be obtained without lowering Tg, an elastic modulus, etc.

Each of the substituent A and the substituent B which the cellulose acylate has may be a single kind or two or more kinds.

A preferred example of the combination of the substituent A and the substituent B is a combination of a benzyl group for the substituent A and an acetyl group for the substituent B.

In the cellulose acylate, it is preferable that the hydrogen atoms of the three hydroxyl groups at the 2-, 3- and 6-positions are substituted with the substituent A and the substituent B in a high degree of substitution. Also, it is preferable that the substituent B substitutes in a higher degree of substitution than that of the substituent A. More specifically, it is preferable that a degree of substitution DS_{A} of the substituent A and a degree of substitution DS_{B} of the substituent B on the hydroxyl groups at the 2-, 3- and 6-positions satisfy the following expressions (5) to (7), respectively.

2.1≦DS_{B}≦2.8 (5)

0.2≦DS_{A}≦0.9 (6)

2.8≦DS_{A}+DS_{B}<3.0 (7)

Specific examples of the cellulose acylate having an aromatic group-containing acyl group (substituent A) and an aliphatic acyl group (substituent B) are shown below, but it should not be construed that the invention is limited to the following examples.

TABLE 2

| No. | Substituent A | DS_{A} | Substituent B | DS_{B} |
|---|---|---|---|---|
| A-1 | Benzoyl group | 0.65 | Acetyl group | 2.35 |
| A-2 | Benzoyl group | 0.65 | Acetyl group | 2.35 |
| A-3 | Benzoyl group | 0.49 | Acetyl group | 2.51 |
| A-4 | Benzoyl group | 0.49 | Acetyl group | 2.46 |
| A-5 | Benzoyl group | 0.49 | Acetyl group | 2.42 |
| A-6 | 4-Heptylbenzoyl group | 0.49 | Acetyl group | 2.51 |
| A-7 | 4-Heptylbenzoyl group | 0.49 | Acetyl group | 2.46 |
| A-8 | 4-Heptylbenzoyl group | 0.49 | Acetyl group | 2.42 |
| A-9 | 4-Heptyloxybenzoyl group | 0.49 | Acetyl group | 2.51 |
| A-10 | 4-Heptyloxybenzoyl group | 0.49 | Acetyl group | 2.46 |
| A-11 | 4-Heptyloxybenzoyl group | 0.49 | Acetyl group | 2.42 |
| A-12 | 4-Hexylbenzoyl group | 0.49 | Acetyl group | 2.51 |
| A-13 | 4-Hexylbenzoyl group | 0.49 | Acetyl group | 2.46 |
| A-14 | 4-Hexylbenzoyl group | 0.49 | Acetyl group | 2.42 |
| A-15 | 4-Hexyloxybenzoyl group | 0.49 | Acetyl group | 2.51 |
| A-16 | 4-Hexyloxybenzoyl group | 0.49 | Acetyl group | 2.46 |
| A-17 | 4-Hexyloxybenzoyl group | 0.49 | Acetyl group | 2.42 |
| A-18 | 2,4,5-Trimethoxybenzoyl group | 0.49 | Acetyl group | 2.51 |
| A-19 | 2,4,5-Trimethoxybenzoyl group | 0.49 | Acetyl group | 2.46 |
| A-20 | 2,4,5-Trimethoxybenzoyl group | 0.49 | Acetyl group | 2.42 |

TABLE 3

| No. | Substituent A | DS_{A} | Substituent B | DS_{B} |
|---|---|---|---|---|
| A-21 | 3,4,5-Trimethoxybenzoyl group | 0.49 | Acetyl group | 2.51 |
| A-22 | 3,4,5-Trimethoxybenzoyl group | 0.49 | Acetyl group | 2.46 |
| A-23 | 3,4,5-Trimethoxybenzoyl group | 0.49 | Acetyl group | 2.42 |
| A-24 | 4-Pentylbenzoyl group | 0.49 | Acetyl group | 2.51 |
| A-25 | 4-Butylbenzoyl group | 0.49 | Acetyl group | 2.51 |
| A-26 | 4-Tert-butylbenzoyl group | 0.49 | Acetyl group | 2.51 |
| A-27 | 2,6-Dimethoxybenzoyl group | 0.49 | Acetyl group | 2.51 |
| A-28 | 3,5-Dimethoxybenzoyl group | 0.49 | Acetyl group | 2.51 |
| A-29 | Benzoyl group | 0.39 | Acetyl group | 2.61 |
| A-30 | Benzoyl group | 0.32 | Acetyl group | 2.68 |
| A-31 | 4-Heptylbenzoyl group | 0.32 | Acetyl group | 2.68 |
| A-32 | 4-Heptylbenzoyl group | 0.32 | Acetyl group | 2.63 |
| A-33 | 4-Heptylbenzoyl group | 0.32 | Acetyl group | 2.59 |
| A-34 | 4-Heptyloxybenzoyl group | 0.32 | Acetyl group | 2.68 |
| A-35 | 4-Heptyloxybenzoyl group | 0.32 | Acetyl group | 2.63 |
| A-36 | 4-Heptyloxybenzoyl group | 0.32 | Acetyl group | 2.59 |
| A-37 | 4-Hexylbenzoyl group | 0.32 | Acetyl group | 2.68 |
| A-38 | 4-Hexylbenzoyl group | 0.32 | Acetyl group | 2.63 |
| A-39 | 4-Hexylbenzoyl group | 0.32 | Acetyl group | 2.59 |
| A-40 | 4-Hexyloxybenzoyl group | 0.32 | Acetyl group | 2.68 |

TABLE 4

| No. | Substituent A | DS_{A} | Substituent B | DS_{B} |
|---|---|---|---|---|
| A-41 | 4-Hexyloxybenzoyl group | 0.32 | Acetyl group | 2.63 |
| A-42 | 4-Hexyloxybenzoyl group | 0.32 | Acetyl group | 2.59 |
| A-43 | 2,4,5-Trimethoxybenzoyl group | 0.32 | Acetyl group | 2.68 |
| A-44 | 2,4,5-Trimethoxybenzoyl group | 0.32 | Acetyl group | 2.63 |
| A-45 | 2,4,5-Trimethoxybenzoyl group | 0.32 | Acetyl group | 2.59 |
| A-46 | 3,4,5-Trimethoxybenzoyl group | 0.32 | Acetyl group | 2.68 |
| A-47 | 3,4,5-Trimethoxybenzoyl group | 0.32 | Acetyl group | 2.63 |
| A-48 | 3,4,5-Trimethoxybenzoyl group | 0.32 | Acetyl group | 2.59 |
| A-49 | 4-Pentylbenzoyl group | 0.32 | Acetyl group | 2.68 |
| A-50 | 4-Butylbenzoyl group | 0.32 | Acetyl group | 2.68 |
| A-51 | 4-Tert-butylbenzoyl group | 0.32 | Acetyl group | 2.68 |
| A-52 | 2,6-Dimethoxybenzoyl group | 0.32 | Acetyl group | 2.68 |
| A-53 | 3,5-Dimethoxybenzoyl group | 0.32 | Acetyl group | 2.68 |
| A-54 | Benzoyl group | 0.55 | Acetyl group | 2.45 |
| A-55 | Benzoyl group | 0.50 | Acetyl group | 2.41 |

### <Degree of Polymerization of Cellulose Acylate>

A degree of polymerization of the cellulose acylate which is preferably used in the invention is from 180 to 700 in terms of a viscosity average degree of polymerization, and in cellulose acetate, it is more preferably from 180 to 550, still more preferably from 180 to 400, and especially preferably from 180 to 350. When the degree of polymerization is too high, a viscosity of a dope solution of the cellulose acylate becomes high, so that the film fabrication by means of casting tends to become difficult. When the degree of polymerization is too low, a strength of the fabricated film is lowered. The average degree of polymerization can be measured by an intrinsic viscosity method by Uda, et al. (Kazuo Uda and Hideo Saito, Sen'i Gakkaishi (Journal of the Society of Fiber Science and Technology, Japan), Vol. 18, No. 1, pages 105 to 120 (1962)). Furthermore, this method is described in detail in JP-A-9-95538.

Also, the molecular weight distribution of the cellulose acylate which is preferably used in the invention is evaluated by means of gel permeation chromatography, and it is preferable that its polydispersity index Mw/Mn (Mw represents a mass average molecular weight, and Mn represents a number average molecular weight) is small, and the molecular weight distribution is narrow. Specifically, the Mw/Mn value is preferably 1.0 to 3.0, more preferably from 1.0 to 2.0, and most preferably from 1.0 to 1.6.

When a low-molecular weight component is removed, while the average molecular weight (degree of polymerization) becomes high, the viscosity becomes lower than that of usual cellulose acylates, and such is useful. The cellulose acylate having a few of a low-molecular weight component can be obtained by removing the low-molecular weight component from a cellulose acylate synthesized by a usual method. The removal of the low-molecular weight component can be carried out by washing the cellulose acylate with an appropriate organic solvent. Incidentally, in the case of manufacturing a cellulose acylate having a few of a low-molecular weight component, it is preferable to adjust an amount of a sulfuric acid catalyst in the acetylation reaction at from 0.5 to 25 parts by mass based on 100 parts by mass of the cellulose. When the amount of the sulfuric acid catalyst is made to fall within the foregoing range, it is possible to synthesize a cellulose acylate which is also preferable from the standpoint of molecular weight distribution (the molecular weight distribution is uniform). During the use at the time of manufacturing the cellulose acylate of the invention, a water content of the cellulose acylate is preferably not more than 2% by mass, more preferably not more than 1% by mass, and especially preferably not more than 0.7% by mass. In general, a cellulose acylate contains water, and it is known that its water content is from 2.5 to 5% by mass. In the invention, in order to allow the cellulose acylate to have the foregoing water content, it is necessary to achieve drying, and a method for achieving drying is not particularly limited so far as the desired water content is presented. In the invention, the synthesis method of such a cellulose acylate is described in detail on pages 7 to 12 of Journal of Technical Disclosure, No. 2001-1745, issued on Mar. 15, 2001 by Japan Institute of Invention and Innovation.

In the cellulose acylate of the invention, so far as the substituent, degree of substitution, degree of polymerization, molecular weight distribution, and so on fall within the foregoing ranges, the cellulose acylate can be used solely or two or more kinds of different cellulose acylates.

### <Additives to Cellulose Acylate>

To the cellulose acylate of the invention, various additives (for example, a compound capable of reducing the optical anisotropy, a wavelength dispersion adjusting agent, a fine particle, a plasticizer, an ultraviolet ray inhibitor, a deterioration inhibitor, a release agent, an optical characteristic adjusting agent, etc.) can be added. These are hereunder described. Also, for the timing of addition, the additives may be added at any timing in a dope fabrication step (fabrication step of a cellulose acylate solution). However, a step of adding the additives for preparation may be added to a final preparation step in the dope fabrication step.

By adjusting the addition amount of such an additive, the foregoing expressions (1) and (2) and so on as the requirements of the invention can be satisfied.

In the relation with an optically anisotropic layer having a λ/4 function (λ/4 layer), in order that a total sum of Rth of the transparent support and Rth of the λ/4 layer and further, Rth in the case of having other layer may satisfy a relation of |Rth|≦20, the Rth (550) of the transparent support is preferably smaller than 0; and it is more preferable to satisfy a relation of −150 Rth (550)≦0, and it is still more preferable to satisfy a relation of −100≦Rth (550)≦0.

From this viewpoint, it is desirable that the cellulose acylate film which is used as the transparent support in the invention contains at least one compound capable of reducing the optical anisotropy, in particular, the retardation Rth in the film thickness direction.

### <Structural Characteristic Feature of Compound Capable of Reducing Optical Anisotropy of Cellulose Acylate Film>

The compound capable of reducing the optical anisotropy of the cellulose acylate film is described.

It is possible to thoroughly reduce the optical anisotropy using a compound capable of suppressing the cellulose acylate in the film from being aligned in a plane thereof, thereby making the Re close to zero. Also, by aligning the cellulose acylate to some extent in the film thickness direction, it is possible to make the Rth smaller than zero.

In order to achieve this, it is advantageous that the compound capable of reducing the optical anisotropy is thoroughly compatible with the cellulose acylate and does not have a rod-shaped structure or a planar structure. Specifically, in the case where the compound has a plurality of planar functional groups such as an aromatic group, a structure having those functional groups not on the same plane but on a non-planar surface.

(Log P value)

In fabricating the cellulose acylate film, of compounds for reducing the optical anisotropy by suppressing the cellulose acylate in the film from being aligned in a plane thereof as described above, a compound having an octanol-water partition coefficient (log P value) of from 0 to 7 is preferable. A compound having a log P value of more than 7 is poor in compatibility with the cellulose acylate and is easy to cause cloudiness or powdering of the film. Also, a compound having a log P value of less than 0 has high hydrophilicity, so that there may be the case where it deteriorates the water resistance of the cellulose acylate film. The log P value is more preferably in the range of from 1 to 6, and especially preferably in the range of 1.5 to 5.

The measurement of the octanol-water partition coefficient (log P value) can be carried out according to the shake-flask method described in Japan Industrial Standards (JIS) Z7260-107 (2000). Also, the octanol-water partition coefficient (log P value) may also be estimated, instead of an actual measurement, by a calculational chemical method or an empirical method. For the calculation method, the Crippen's fragmentation method (J. Chem. Inf. Comput. Sci., 27, 21 (1987)), the Viswanadhan's fragmentation method (J. Chem. Inf. Comput. Sci., 29, 163 (1989)), the Broto's fragmentation method (Eur. J. Med. Chem.-Chim. Theor., 19, 71 (1984)), and the like are preferably adopted, and the Crippen's fragmentation method (J. Chem. Inf. Comput. Sci., 27, 21 (1987)) is more preferably adopted. In the case where a certain compound shows a different log P value depending on the measuring method or the calculation method, the Crippen's fragmentation method is preferably adopted for determining as to whether the compound falls within the scope of the invention. Incidentally, the log P values described in this specification are those determined by the Crippen's fragmentation method (J. Chem. Inf. Comput. Sci., 27, 21 (1987)).

### <Physical Properties of Compound Capable of Reducing Optical Anisotropy>

The compound capable of reducing the optical anisotropy may or may not contain an aromatic group. The compound capable of reducing the optical anisotropy preferably has a molecular weight of from 150 to 3,000, more preferably from 170 to 2,000, and especially preferably from 200 to 1,000. When the molecular weight falls within the foregoing range, the compound capable of reducing the optical anisotropy may have a specified monomer structure, or may have an oligomer structure or a polymer structure in which a plurality of the monomer units are combined.

The compound capable of reducing the optical anisotropy is preferably a liquid at 25° C. or a solid having a melting point of from 25 to 250° C., and more preferably a liquid at 25° C. or a solid having a melting point of from 25 to 200° C. It is also preferable that the compound capable of reducing the optical anisotropy does not volatilize in the course of casting and drying a dope for fabricating a cellulose acylate film.

An addition amount of the compound capable of reducing the optical anisotropy is preferably from 0.01 to 30% by mass, more preferably from 1 to 25% by mass, and especially preferably from 5 to 20% by mass relative to the cellulose acylate.

The compound capable of reducing the optical anisotropy may be used solely or in admixture of two or more kinds thereof in an arbitrary ratio.

The timing for adding the compound capable of reducing the optical anisotropy may be at any time during the process for dope fabrication, and may be at the end of the process for the dope preparation.

In the compound capable of reducing the optical anisotropy, an average content of the subject compound in a portion of up to 10% of the total film thickness from the surface of at least one side is from 80 to 99% of the average content of the subject compound in a central part of the cellulose acylate film. An existence amount of the subject compound can be, for example, determined by measuring the amount of the compound on the surface or in the central part according to a method using an infrared absorption spectrum described in JP-A-8-57879.

Examples of the compound capable of reducing the optical anisotropy of the cellulose acylate film which is preferably used in the invention include compounds described in paragraphs [0035] to [0058] of JP-A-2006-199855, but it should not be construed that the invention is limited to these compounds.

### (UV Absorber)

The optical film of the invention can be used as a viewing-side protective film of a second polarizing plate of a liquid crystal display device, and in that case, the optical film of the invention is easily influenced by external light, in particular, ultraviolet rays. For that reason, it is desirable that any one of members constituting the protective film contains a UV absorber (ultraviolet ray absorber). It is preferable that the UV absorber is contained in the transparent support, the optically anisotropic layer or the like constituting the protective film.

Above all, the UV absorber is preferably a compound having absorption in an ultraviolet region of from 200 to 400 nm and capable of reducing both |Re (400)−Re (700)| and |Rth (400)−Rth (700)| of the film. It is desirable to use such a compound in an amount of from 0.01 to 30% by mass relative to the solids of the cellulose acylate.

Also, in recent years, for liquid crystal display devices such as a television receiver, a laptop personal computer, and a mobile type portable terminal, in order to enhance the luminance with a low electric power, there are demanded those excellent in transmittance of an optical member to be used in each liquid crystal display device. At that point, in the case of adding a compound having absorption in an ultraviolet region of from 200 to 400 nm and capable of reducing both |Re (400)−Re (700)| and |Rth (400)−Rth (700)| of the film to the cellulose acylate film, it is required that the spectral transmittance is excellent. In the cellulose acylate film of the invention, it is desirable that not only the spectral transmittance at a wavelength of 380 nm is from 45 to 95%, but the spectral transmittance at a wavelength of 350 nm is not more than 10%.

From the viewpoint of volatility, a molecular weight of the UV absorber which is preferably used in the invention as described above is preferably from 250 to 1,000, more preferably from 260 to 800, still more preferably from 270 to 800, and especially preferably from 300 to 800. When the molecular weight of the UV absorber falls within the foregoing range, the UV absorber may have a specified monomer structure, or may have an oligomer structure or a polymer structure in which a plurality of the monomer units are combined.

It is preferable that the UV absorber does not volatilize in the course of casting and drying a dope for fabricating a cellulose acylate film.

Examples of the UV absorber of the cellulose acylate film which is preferably used in the invention include compounds described in paragraphs [0059] to [0135] of JP-A-2006-199855.

### <Mat Agent Fine Particle>

It is preferable to add a fine particle as a mat agent to the cellulose acylate film. As the fine particle to be used, there can be exemplified those made of silicon dioxide, titanium dioxide, aluminum oxide, zirconium oxide, calcium carbonate, talc, clay, sintered kaolin, sintered calcium silicate, hydrated calcium silicate, aluminum silicate, magnesium silicate, and calcium phosphate. As the fine particle, one containing silicon is preferable because of its low turbidity, and silicon dioxide is especially preferable. The fine particle of silicon dioxide has a primary average particle diameter of not more than 20 nm and an apparent specific gravity of 70 g/L or more. One having an average diameter of primary particle of as small as from 5 to 16 nm is more preferable because it can reduce the haze of the film. The apparent specific gravity is preferably from 90 to 200 g/L or more, and more preferably from 100 to 200 g/L or more. One with a larger apparent specific gravity is preferable because it can form a high-concentration dispersion liquid, resulting in improvements of the haze and the aggregate.

In general, such a fine particle forms a secondary particle having an average particle diameter of from 0.1 to 3.0 μm. Such a fine particle is present in the form of an aggregate of primary particles in the film, and it forms concaves and convexes of from 0.1 to 3.0 μm on the film surface. The secondary average particle diameter is preferably from 0.2 to 1.5 μm, more preferably from 0.4 to 1.2 μm, and most preferably from 0.6 to 1.1 μm. The primary or secondary particle diameter is defined as follows. The particles in the film are observed by a scanning electron microscope, and a diameter of the circle circumscribing the particle is taken as the particle diameter. Also, 200 particles are observed while changing the site. An average value thereof is taken as the average particle diameter.

As the fine particle of silicon dioxide, there can be used commercially available products such as AEROSIL R972, R972V, R974, R812, 200, 200V, 300, R202, OX50, and TT600 (all of which are manufactured by Nippon Aerosil Co., Ltd.). The fine particle of zirconium oxide is commercially available under trade names of AEROSIL R976 and R811 (both of which are manufactured by Nippon Aerosil Co., Ltd.), and these commercially available products are usable.

Of these, AEROSIL 200V and AEROSIL R972V are a fine particle of silicon dioxide having a primary average particle diameter of not more than 20 nm and an apparent specific gravity of 70 g/L or more, and these are especially preferable because these have a large effect for reducing a coefficient of friction while keeping the turbidity of the optical film low.

In the invention, in order to obtain a cellulose acylate film having particles having a small secondary average particle diameter, there may be considered some techniques for preparing a dispersion liquid of fine particles. For example, there is a method in which a fine particle dispersion liquid obtained by stirring and mixing a solvent and a fine particle is previously formed; this fine particle dispersion liquid is added to a small amount of a separately prepared cellulose acylate solution and dissolved therein with stirring; and the resulting solution is further mixed with a main cellulose acylate solution (dope solution). This method is a preferable preparation method from the standpoints that dispersibility of the silicon dioxide fine particle is good; and that the silicon dioxide fine particle is less likely aggregated again. Besides, there is another method in which a small amount of a cellulose ester is added to a solvent and dissolved therein with stirring; a fine particle is then added thereto and dispersed therein by using a dispersing machine, thereby taking the resulting dispersion liquid as a fine particle-added solution; and this fine particle added solution is then sufficiently mixed with a dope solution by using an inline mixer. Though the invention is not limited to these methods, a concentration of silicon dioxide at the time of mixing a silicon dioxide fine particle with a solvent or the like and dispersing therein is preferably from 5 to 30% by mass, more preferably from 10 to 25% by mass, and most preferably 15 to 20% by mass. A higher dispersion concentration is preferable because the solution turbidity becomes lower relative to the addition amount, resulting in improvements of the haze and the aggregate. An addition amount of the mat agent fine particle in the final cellulose acylate dope solution is preferably from 0.01 to 1.0 g, more preferably from 0.03 to 0.3 g, and most preferably from 0.08 to 0.16 g per m³.

As the solvents to be used, there are exemplified lower alcohols. As the lower alcohol, methyl alcohol, ethyl alcohol, propyl alcohol, isopropyl alcohol, butyl alcohol, or the like is preferable. Though other solvents than lower alcohols are not particularly limited, it is preferable to use the solvent which is used at the time of the film formation of a cellulose acylate.

### <Plasticizer, Deterioration Inhibitor and Release Agent>

Besides the compound capable of reducing the optical anisotropy and the UV absorber, to the cellulose acylate film of the invention, there can be added various additives (for example, a plasticizer, an ultraviolet ray inhibitor, a deterioration inhibitor, a release agent, an infrared ray absorber, etc.) according to an application, as described previously. They may be either a solid or an oily substance. That is, though there is no particular limitation on the melting point or the boiling point, for example, mention may be made of mixing of ultraviolet ray absorbing materials of not higher than 20° C. and 20° C. or higher, respectively and similarly, mixing of a plasticizer. For example, they are described in JP-A-2001-151901, or the like. Moreover, the infrared ray absorber is described in, for example, JP-A-2001-194522. Also, for the timing of addition, the additives may be added at any timing in the dope fabrication step. However, a step of adding the additives for preparation may be added to a final preparation step in the dope fabrication step for carrying out the addition. Still further, the addition amount of each additive is not particularly limited so far as its function is revealed. Also, in the case where the cellulose acylate film is formed of multiple layers, the type and the addition amount of the additive in each layer may be different. Though these are described in, for example, JP-A-2001-151902, these are a conventionally known technique. For the details thereof, there can be preferably used materials described in details on pages 16 to 22 of Journal of Technical Disclosure, No. 2001-1745, issued on Mar. 15, 2001 by Japan Institute of Invention and Innovation.

### <Polymer Plasticizer>

In the invention, from the viewpoint of making the humidity dependency of the retardation Rth in the film thickness direction of the transparent support, it is preferable to incorporate a polymer plasticizer having a number average molecular weight of from 500 to 10,000 and having a repeating unit composed of a dicarboxylic acid and a diol in a content of 30% by mass or more relative to the cellulose acylate.

The content of the polymer plasticizer is preferably from 30 to 80% by mass, and more preferably from 35 to 60% by mass relative to the cellulose acylate. What the content of the polymer plasticizer is not more than 80% by mass is preferable because it is easy to suppress bleed-out from the film.

Incidentally, in the case of incorporating two or more kinds of polymer plasticizers, the content of a total sum of the two or more kinds of polymer plasticizers may fall within the foregoing range.

A number average molecular weight (Mn) of the polymer plasticizer in the invention is preferably from 500 to 10,000, more preferably from 500 to 8,000, and still more preferably from 700 to 8,000. When the number average molecular weight of the polymer plasticizer is 500 or more, the volatility becomes low, and film failure or step staining to be caused due to volatilization under a high-temperature condition at the time of stretching the cellulose ester film hardly occurs. Also, when the number average molecular weight of the polymer plasticizer is not more than 10,000, the compatibility with the cellulose ester becomes high, and bleed-out at the time of film formation and at the time of heat stretching hardly occurs.

The number average molecular weight of the polymer plasticizer in the invention can be measured and evaluated by means of gel permeation chromatography.

It is preferable that the polymer plasticizer which is used in the invention is synthesized from a diol having from 2 to 10 carbon atoms and a dicarboxylic acid having from 4 to 10 carbon atoms. As the synthesis method, a known method such as dehydration condensation reaction of a dicarboxylic acid and a diol; and addition of an anhydrous dicarboxylic acid to a diol and dehydration condensation reaction can be utilized.

The dicarboxylic acid and the diol which can be preferably used for the synthesis of the polymer plasticizer in the invention are hereunder described.

### (Dicarboxylic Acid)

As the dicarboxylic acid, any of aliphatic dicarboxylic acids and aromatic dicarboxylic acids are useful.

Examples of the aliphatic dicarboxylic acid include oxalic acid, malonic acid, succinic acid, maleic acid, fumaric acid, glutaric acid, adipic acid, suberic acid, azelaic acid, cyclohexanedicarboxylic acid, and sebacic acid. Of these, succinic acid or adipic acid is preferable.

Examples of the aromatic dicarboxylic acid include phthalic acid, terephthalic acid, and isophthalic acid. Of these, phthalic acid or terephthalic acid is preferable, and terephthalic acid is especially preferable.

A carbon number of the dicarboxylic acid which is used in the invention is preferably from 4 to 10, more preferably from 4 to 8, and still more preferably from 4 to 6. In the invention, a mixture of two or more kinds of dicarboxylic acids may be used. In that case, it is preferable that an average carbon number of the two or more kinds of dicarboxylic acids falls within the foregoing range. What the carbon number of the dicarboxylic acid falls within the foregoing range is preferable because the water content of the cellulose acylate film is adequately reduced, and therefore, excellent compatibility with the cellulose acid is revealed while reducing the humidity dependency of Rth, and bleed-out hardly occurs even at the time of film formation and at the time of heat stretching of the cellulose acylate film. (Diol)

Examples of the diol (glycol) include aliphatic diols and aromatic diols, with aliphatic diols being preferable.

As the aliphatic diol, there can be exemplified alkyl diols and alicyclic diols. Examples thereof include ethylene glycol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol(neopentyl glycol), 2,2-diethyl-1,3-propanediol(3,3-dimethylolpentane), 2-n-butyl-2-ethyl-1,3-propanediol(3,3-dimethyloheptane), 3-methyl-1,5-pentanediol, 1,6-hexanediol, 1,4-cyclohexanediol, 1,4-cyclohexanedimethanol, 2,2,4-trimethyl-1,3-pentanediol, 2-ethyl-1,3-hexanediol, 2-methyl-1,8-octanediol, 1,9-nonanediol, 1,10-decanediol, and diethylene glycol.

The aliphatic diol is preferably at least one member of ethylene glycol, 1,2-propanediol, and 1,3-propanediol, and especially preferably at least one member of ethylene glycol and 1,2-propanediol. In the case of using two kinds of aliphatic diols, it is preferable to use ethylene glycol and 1,2-propanediol.

A carbon number of the glycol is preferably from 2 to 10, more preferably from 2 to 6, and especially preferably from 2 to 4. In the case of two or more kinds of glycols, it is preferable that an average carbon number of the two or more kinds of glycols falls within the foregoing range. What the carbon number of the glycol falls within the foregoing range is preferable because the water content of the cellulose acylate film is adequately reduced, and therefore, excellent compatibility with the cellulose acylate is revealed while reducing the humidity dependency of Rth, and bleed-out hardly occurs even at the time of film formation and at the time of heat stretching of the cellulose acylate film.

### (Sealing)

It does not matter whether the both terminals of the polyester based oligomer as the polymer plasticizer according to the invention are sealed or unsealed.

In the case where the both terminals of the polyester based oligomer are unsealed, the oligomer is preferably a polyester polyol.

In the case where the both terminals of the polyester based oligomer are sealed, it is preferable to achieve sealing upon reaction with a monocarboxylic acid. At that time, the both terminals of the oligomer are a monocarboxylic acid residue. The residue as referred to herein means a partial structure of the oligomer and represents a partial structure having a characteristic feature of a monomer forming the oligomer. For example, a monocarboxylic acid residue formed from a monocarboxylic acid R—COOH is R—CO—. The monocarboxylic acid residue is preferably an aliphatic monocarboxylic acid residue, more preferably an aliphatic monocarboxylic acid residue having from 2 to 22 carbon atoms, still preferably an aliphatic monocarboxylic acid residue having from 2 to 3 carbon atoms, and especially preferably an aliphatic monocarboxylic acid residue having 2 carbon atoms.

When the carbon number of the monocarboxylic acid residue at the both terminals of the polyester based oligomer is not more than 3, the volatility becomes low, a loss in weight on heating of the oligomer does not become large, and the generation of step staining or the generation of planar failure can be reduced. That is, the monocarboxylic acid which is used for sealing is preferably an aliphatic monocarboxylic acid. The monocarboxylic acid is more preferably an aliphatic monocarboxylic acid having from 2 to 22 carbon atoms, still preferably an aliphatic monocarboxylic acid having from 2 to 3 carbon atoms, and especially preferably an aliphatic monocarboxylic acid having 2 carbon atoms. For example, acetic acid, propionic acid, butanoic acid, a benzoic acid, or a derivative thereof is preferable; acetic acid or propionic acid is more preferable; and acetic acid (a terminal of which is an acetyl group) is the most preferable. A mixture of two or more kinds of monocarboxylic acids may be used for sealing.

In the case where the both terminals are sealed, it is possible to obtain a cellulose ester film which hardly becomes a solid in shape in the state at ordinary temperature, becomes favorable in handling, and has excellent humidity stability and durability as a polarizing plate.

Also, with respect to the plasticizer, the Examples as described later include those in which the plasticizer is not added. Needless to say, in the case of a compound capable of bringing about an effect as the plasticizer, such as a compound capable of reducing the optical anisotropy, it is not necessary to add the plasticizer.

### <Manufacturing Step of Cellulose Acylate Film>

### <Dissolution Step>

The preparation of the cellulose acylate solution (dope) is not particularly limited with respect to its dissolution method, and it may be carried out at room temperature or by means of cooling dissolution or high-temperature dissolution or a combination thereof. With respect to the preparation of the cellulose acylate solution in the invention and respective steps following the dissolution step, such as solution concentration and filtration, the manufacturing steps described in detail in Journal of Technical Disclosure, No. 2001-1745, pages 22 to 25, issued on Mar. 15, 2001 by Japan Institute of Invention and Innovation are preferably adopted.

### (Degree of Clearness of Dope Solution)

A degree of clearness of the dope of the cellulose acylate solution is preferably 85% or more, more preferably 88% or more, and still more preferably 90% or more. In the invention, it was confirmed that the various additives were thoroughly dissolved in the cellulose acylate dope solution. As a specific calculation method of a degree of clearness of the dope, the dope solution was injected into a glass cell of 1 cm in square, and its absorbance at 550 nm was measured by a spectrophotometer (UV-3150, manufactured by Shimadzu Corporation). An absorbance of only the solvent was measured in advance as a blank, and the degree of clearness of the cellulose acylate solution was calculated from a ratio to the absorbance of the blank.

### <Casting, Drying and Winding Steps>

Next, the manufacturing method of a film using the cellulose acylate solution is described. As a method and equipment for manufacturing the cellulose acylate film according to the invention, a solution casting film formation method and a solution casting film formation apparatus which have been conventionally provided for the manufacture of a cellulose triacetate film are adopted. A dope (cellulose acylate solution) prepared in a dissolution machine (pot) is once stored in a storage pot, and after defoaming of bubbles contained in the dope, the dope is subjected to final preparation. The dope is discharged from a dope exhaust and fed into a pressure die via, for example, a pressure constant-rate gear pump capable of feeding the dope at a constant flow rate at a high accuracy depending upon a rotational rate; the dope is uniformly cast from a nozzle (slit) of the pressure die onto a metallic support continuously running in an endless manner in the casting section; and at the peeling point where the metallic support has substantially rounded in one cycle, the half-dried dope film (also called a web) is peeled away from the metallic support. The obtained web is clipped at both ends and dried by conveying with a tenter while keeping a width. Subsequently, the resulting film is mechanically conveyed with a group of rolls in a dryer to terminate the drying and then wound in a roll form with a winder in a prescribed length. A combination of the tenter and the dryer of a group of rolls varies depending upon the purpose. In the solution casting film formation method to be used for a functional protective film that is an optical member for electronic display which is a main application of the cellulose acylate film, in addition to a solution casting film forming apparatus, a coating apparatus is frequently added for the surface processing onto a film such as a subbing layer, an antistatic layer, an anti-halation layer, and a protective layer. These are described in detail in Journal of Technical Disclosure, No. 2001-1745, pages 25 to 30, issued on Mar. 15, 2001 by Japan Institute of Invention and Innovation and are classified into casting (including co-casting), metallic support, drying, peeling, and so on. These can be preferably adopted in the invention.

Also, a thickness of the transparent support is preferably from 10 to 120 μm, more preferably from 20 to 100 μm, and still more preferably from 30 to 90 μm.

A linear thermal expansion coefficient of the transparent support is preferably not more than 65 ppm/° C., and more preferably not more than 55 ppm/° C. When the linear thermal expansion coefficient of the transparent support falls within the foregoing range, a dimensional change of the transparent support to be caused due to a temperature change is small, so that the generation of a crosstalk by the temperature change can be suppressed.

### <Optically Anisotropic Layer>

In the optical film of the invention, the optically anisotropic layer has a function to convert λ/4 layer, i.e., linear polarization to circular polarization. Though there are a variety of methods in forming an optically anisotropic layer having a function as a λ/4 plate, in particular, it is preferable to form the optically anisotropic layer by polymerizing a rod-shaped liquid crystalline compound or a discotic compound in a stretched state and fixing it.

Rod-shaped liquid crystalline compounds can be combined in every sort for the purpose of optimizing optical performance, a manufacturing adaptability, and so on.

In general, a liquid crystalline polymer compound has a higher An than that of a crystalline low-molecular weight compound having the same kind of mesogen, and therefore, it is able to achieve a necessary retardation in a thin film thickness. Also, the liquid crystalline polymer compound has a high viscosity, so that cissing at the time of coating, which causes defective alignment, hardly occurs.

As the rod-shaped liquid crystalline compound which can be used for the optically anisotropic layer of the invention, a compound having a polymerizable group is preferable as described previously. For example, it can be selected and used among compounds described in Makromol. Chem., Vol. 190, page 2255 (1989), Advanced Materials, Vol. 5, page 107 (1993), U.S. Pat. Nos. 4,683,327, 5,622,648 and 5,770,107, WO95/22586, WO95/24455, WO97/00600, WO98/23580, WO98/52905, JP-A-1-272551, JP-A-6-16616, JP-A-7-110469, JP-A-11-80081, JP-T-11-513019, and Japanese Patent Application No. 2001-64627.

As the low-molecular weight rod-shaped liquid crystalline compound, a compound represented by the following general formula (II) is preferable.

Q1-L1-Cy1-L2-(Cy2-L3)ₙ-Cy3-L4-Q2 General Formula (II)

In the general formula (II), each of Q1 and Q2 independently represents a polymerizable group; each of L1 and L4 independently represents a divalent connecting group; each of L2 and L3 independently represents a single bond or a divalent connecting group; each of Cy1, Cy2, and Cy3 independently represents a divalent cyclic group; and n is 0, 1, or 2.

The polymerizable rod-shaped liquid crystalline compound is hereunder further described.

In the general formula (II), each of Q1 and Q2 independently represents a polymerizable group. The polymerization reaction of the polymerizable group is preferably addition polymerization (including ring-opening polymerization) or condensation polymerization. In other words, the polymerizable group is preferably a functional group capable of undergoing an addition polymerization reaction or a condensation polymerization reaction.

The optically anisotropic layer in the invention may be any of a type of entirely coating the λ/4 layer, or a patterning retardation layer including a plurality of regions where directions of a slow axis are different from each other. However, from a reason for not causing image deterioration such as flicker in the case of applying the optical film of the invention to a liquid crystal display device, it is preferable that the optically anisotropic layer is a patterning retardation layer. Examples of the patterning retardation layer include a patterning retardation layer formed in such a manner that plural right eye retardation regions and left eye retardation regions are, for example, alternately formed in every line and patterned so as to produce the right eye retardation regions and the left eye retardation regions.

In the case of a type of entirely coating the λ/4 layer, the optically anisotropic layer is applied to a shutter glass system. In order to alternately display a right eye image and a left eye image in every line, a system of disposing the λ/4 layer on the viewing-side polarizer in such a manner that its slow direction is intersected at 90° can be applied to a polarized glass system.

In the case of 3D display using polarized glasses, there is an index that is a crosstalk as an important characteristic controlling the image quality. This index expresses a rate of a quantity of light of left eye image light which is not desired to enter a right eye to a quantity of light of right eye image light (information light) which should enter the right eye through a pair of glasses, and it is ideally 0%.

In the case where the optical film of the invention is set in an image display device such as a liquid crystal display and adequately combined with a pair of glasses, thereby undergoing 3D display, a crosstalk which is caused due to a deviation of an absolute value of the retardation or wavelength dispersion of the retardation can be reduced.

In order that the optical film of the invention may satisfy a relation of |Rth|≦20, it is preferable that the optically anisotropic layer satisfies a relation of 55≦Rth (550)≦75.

### <Antireflection Film>

### (Antireflection Layer)

In the optical film of the invention, one or more antireflection films may be provided on the uppermost surface. In addition to an antireflection layer, other functional films may be provided in the antireflection film. In particular, in the invention, an antireflection film in which at least a light scattering layer and a low refractive index layer are stacked in this order, or an antireflection film in which a middle refractive index layer, a high refractive index layer, and a low refractive index layer are stacked in this order is suitably used. This is because in particular, in the case of displaying a 3D image, the generation of flicker to be caused due to reflection of external light can be effectively prevented from occurring.

As to the antireflection film, one having an antireflection layer provided on a transparent support may be provided on the optical film of the invention, or the transparent support of the optical film of the invention may also serve as a support of an antireflection film. In the latter case, a functional layer such as an antireflection layer may be provided directly on the transparent support of the optical film of the invention.

Preferred examples thereof are hereunder described.

A preferred example of the antireflection layer having a light scattering layer and a low refractive index layer provided on the optical film of the invention is described.

In the light scattering layer of the invention, mat particles are dispersed; it is preferable that a refractive index of the raw material in a portion other than the mat particles of the light scattering layer is in the range of from 1.50 to 2.00; and it is preferable that a refractive index of the low refractive index layer is in the range of from 1.35 to 1.49. In the invention, the light scattering layer has both antiglare properties and hard coat properties, and it may be constituted of a single layer or plural layers, for example, from 2 to 4 layers.

With respect to the shape of surface irregularities of the antireflection layer, when the antireflection layer is designed in such a manner that a center line average roughness Ra is from 0.08 to 0.40 μm; a ten-point average roughness Rz is not more than 10 times of Ra; an average peak-valley distance Sm is from 1 to 100 μm; a standard deviation of the peak height measured from the deepest point is not more than 0.5 μm; a standard deviation of the average peak-valley distance Sm on the basis of the center line is not more than 20 μm; and a ratio of face with a tilt angle of 0 to 5 degree is 10% or more, sufficient antiglare properties and an uniform mat feeling through visual observation are achieved, and hence, such is preferable.

Also, under a C light source, it is also preferable that the reflected light shows tint values a* of from −2 to 2 and b* of from −3 to 3 and a ratio of the minimum refractive index to the maximum refractive index of from 0.5 to 0.99 within the range of from 380 to 780 nm. This is because a neutral tint of the reflected light can be thus obtained. It is also preferable that the b* value of transmitted light under the C light source is from 0 to 3 because yellowness in white display is reduced in the case of being applied to a display device.

Also, it is preferable that in the case of inserting a lattice of 120 μm×40 μm between a face light source and the antireflection film of the invention and measuring luminance distribution on the film, a standard deviation of the luminance distribution is not more than 20. This is because the glare is reduced when the film of the invention is applied to a high-definition panel.

With respect to optical characteristics, it is preferable that the antireflection layer of the invention has a mirror reflectance of not more than 2.5%, a transmittance of 90% or more, and a 60° glossiness of not more than 70% or less. This is because the reflection of external light can be suppressed, and the visibility is enhanced. In particular, the mirror reflectance is more preferably not more than 1%, and most preferably not more than 0.5%. To prevent glare on a high-definition LCD panel and reduce blur of letters or characters, it is preferable to achieve a haze of from 20 to 50%, an inner haze/total haze value (ratio) of from 0.3 to 1, a decrease between the haze value till the light scattering layer and the haze value after the formation of a low refractive index layer of not more than 15%, a transmission image clearness at a frame width of 0.5 mm of from 20 to 50%, and a transmission ratio of perpendicular transmission light/direction inclined by 2° against the perpendicular direction of from 1.5 to 5.0.

### (Low Refractive Index Layer)

A refractive index of the low refractive index layer of the antireflection film according to the invention is in the range of from 1.20 to 1.49, and preferably from 1.30 to 1.44. Furthermore, from the standpoint of achieving a low reflectance, it is preferable that the low refractive index layer satisfies the following numerical expression (IX).

(mλ/4)×0.7<n1d1<(mλ/4)<1.3 Numerical Expression (IX)

In the numerical expression (IX), m represents a positive odd number; n1 represents a refractive index of the low refractive index layer; and d1 represents a film thickness (nm) of the low refractive index layer. Also, λ represents a wavelength and is a value in the range of from 500 to 550 nm.

A raw material for forming the low refractive index layer according to the invention is hereunder described.

The low refractive index layer according to the invention contains a fluorine-containing polymer as a low refractive index binder. The fluorine-containing polymer is preferably a fluorine-containing polymer which has a coefficient of dynamic friction of from 0.03 to 0.20, a contact angle against water of from 90° to 120° and a sliding angle of pure water of not more than 70° and which is crosslinked by heat or ionizing radiations. When the antireflection film according to the invention is installed in an image display device, the lower the peeling force from a commercially available adhesive tape, the more easily the seal or scratch pad is stripped off after being stuck, and hence, such is preferable. The peeling force is preferably not more than 500 gf, more preferably not more than 300 gf, and most preferably not more than 100 gf. Also, the higher the surface hardness measured with a micro hardness tester, the more hardly scuffing occurs. The surface hardness is preferably 0.3 GPa or more, and more preferably 0.5 GPa or more.

Examples of the fluorine-containing polymer which is used for the low refractive index layer include products obtained by hydrolysis or dehydration condensation of a perfluoroalkyl group-containing silane compound (for example, (heptadecafluoro-1,1,2,2-tetrahydrodecyl)triethoxysilane, etc.); and in addition to the above, fluorine-containing copolymers having a fluorine-containing monomer unit and a constituent unit for imparting crosslinking reactivity.

Specific examples of the fluorine-containing monomer include fluoroolefins (for example, fluoroethylene, vinylidene fluoride, tetrafluoroethylene, perfluorooctylethylene, hexafluoropropylene, perfluoro-2,2-dimethyl-1,3-dioxole, etc.), partly or completely fluorinated alkyl ester derivatives of (meth)acrylic acid (for example, BISCOAT 6FM (manufactured by Osaka Organic Chemical Industry Ltd.), M-2020 (manufactured by Daikin Industries, Ltd.), etc.); and completely or partially fluorinated vinyl ethers. Of these, perfluoroolefins are preferable; and hexafluoropropylene is especially preferable from the viewpoints of refractive index, solubility, transparency, availability and the like.

Examples of the constituent unit for imparting crosslinking reactivity include constituent units obtainable by polymerization of a monomer having a self-crosslinking functional group in a molecule thereof in advance, such as glycidyl(meth)acrylate and glycidyl vinyl ether; constituent units obtainable by polymerization of a monomer having a carboxyl group, a hydroxyl group, an amino group, a sulfo group, etc. (for example, (meth)acrylic acid, methylol(meth)acrylate, hydroxyalkyl(meth)acrylates, allyl acrylate, hydroxyethyl vinyl ether, hydroxybutyl vinyl ether, maleic acid, crotonic acid, etc.); and constituent units in which a crosslinking reactive group such as a (meth)acryloyl group is introduced into such a constituent unit by a polymeric reaction (for example, the crosslinking reactive group can be introduced by a method for allowing acrylic acid chloride to act on a hydroxyl group).

Also, besides the foregoing fluorine-containing monomer unit and constituent unit for imparting crosslinking reactivity, from the viewpoints of solubility in a solvent, transparency of a film, and so on, a fluorine atom-free monomer can be properly copolymerized. The monomer unit which can be used in combination is not particularly limited, and examples thereof include olefins (for example, ethylene, propylene, isoprene, vinyl chloride, vinylidene chloride, etc.), acrylic acid esters (for example, methyl acrylate, ethyl acrylate, 2-ethylhexyl acrylate, etc.), methacrylic acid esters (for example, methyl methacrylate, ethyl methacrylate, butyl methacrylate, ethylene glycol dimethacrylate, etc.), styrene derivatives (for example, styrene, divinylbenzene, vinyltoluene, α-methylstyrene, etc.), vinyl ethers (for example, methyl vinyl ether, ethyl vinyl ether, cyclohexyl vinyl ether, etc.), vinyl esters (for example, vinyl acetate, vinyl propionate, vinyl cinnamate, etc.), acrylamides (for example, N-tert-butyl acrylamide, N-cyclohexyl acrylamide, etc.), methacrylamides, and acrylonitrile derivatives.

The foregoing polymer may be properly used in combination with a curing agent described in JP-A-10-25388 and JP-A-10-147739.

### (Light Scattering Layer)

The light scattering layer is formed for the purpose of imparting light diffusibility due to surface scattering and/or internal scattering and hard coat properties for enhancing resistance to scuffing of the film. In consequence, the light scattering layer is formed so as to contain a binder for imparting hard coat properties, a mat particle for imparting light diffusibility, and if desired, an inorganic filler for realizing a high refractive index, preventing crosslinking shrinkage or realizing a high strength.

From the viewpoints of imparting hard coat properties and suppressing the generation of curl and the deterioration of brittleness, a film thickness of the light scattering layer is preferably from 1 to 10 μm, and more preferably from 1.2 to 6 μm.

The binder of the light scattering layer is preferably a polymer having a saturated hydrocarbon chain or a polyether chain as the principal chain, and more preferably a polymer having a saturated hydrocarbon chain as the principal chain. Also, it is preferable that the binder polymer has a crosslinking structure. As the binder polymer having a saturated hydrocarbon chain as the principal chain, polymers of an ethylenically unsaturated monomer are preferable. As the binder polymer having a saturated hydrocarbon chain as the principal chain and having a crosslinking structure, (co)polymers of a monomer having two or more ethylenically unsaturated groups are preferable. In order to make the binder polymer have a high refractive index, those having an aromatic ring or containing at least one atom selected from a halogen atom other than fluorine, a sulfur atom, a phosphorus atom, and a nitrogen atom in the monomer structure can be chosen, too.

Examples of the monomer having two or more ethylenically unsaturated groups include esters of a polyhydric alcohol and (meth)acrylic acid (for example, ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylates, polyester polyacrylates, etc.) and ethylene oxide modified products thereof; vinylbenzene and derivatives thereof (for example, 1,4-divinylbenzene, 2-acryloylethyl 4-vinylbenzoate, 1,4-divinylcyclohexanone, etc.); vinylsulfones (for example, divinylsulfone, etc.); acrylamides (for example, methylenebisacrylamide, etc.); and methacrylamides. Two or more kinds of the foregoing monomers may be used in combination.

Specific examples of the high refractive index monomer include bis(4-methacryloylthiophenyl)sulfide, vinylnaphthalene, vinylphenyl sulfide, and 4-methacryloxyphenyl-4′-methoxyphenyl thioether. Also two or more kinds of these monomers may be used in combination.

The polymerization of such an ethylenically unsaturated group-containing monomer can be carried out upon irradiation with ionizing radiations or heating in the presence of a photo radical initiator or a heat radical initiator.

In consequence, the antireflection film can be formed by preparing a coating solution containing an ethylenically unsaturated group-containing monomer, a photo radical initiator or a heat radical initiator, a mat particle, and an inorganic filler, coating this coating solution on a transparent support and then curing it by a polymerization reaction with ionizing radiations or heat. As such a photo radical initiator, known photo radical initiators can be used.

The polymer having a polyether as the principal chain is preferably a ring-opening polymer of a polyfunctional epoxy compound. The ring-opening polymerization of a polyfunctional epoxy compound can be carried out upon irradiation with ionizing radiations or heating in the presence of a photo acid generator or a heat acid generator.

In consequence, the antireflection film can be formed by preparing a coating solution containing a polyfunctional epoxy compound, a photo acid generator or a heat acid generator, a mat particle, and an inorganic filler, coating this coating solution on a transparent support and then curing it by a polymerization reaction with ionizing radiations or heat.

A crosslinking structure may be introduced into the binder polymer by introducing a crosslinking functional group into the polymer by using a crosslinking functional group-containing monomer in place of, or in addition to, the monomer having two or more ethylenically unsaturated groups and allowing this crosslinking functional group to react.

Examples of the crosslinking functional group include an isocyanate group, an epoxy group, an aziridine group, an oxazoline group, an aldehyde group, a carbonyl group, a hydrazine group, a carboxyl group, a methylol group, and an active methylene group. As the monomer for the purpose of introducing a crosslinking structure, vinylsulfonic acid, acid anhydrides, cyano acrylate derivatives, melamine, etherified methylol, esters, urethanes, and metal alkoxides (for example, tetramethoxysilane, etc.) can be utilized. A functional group which exhibits crosslinking properties as a result of decomposition reaction, for example, a block isocyanate group, may also be used. That is, in the invention, the crosslinking functional group may also be a functional group which does not promptly exhibit reactivity but exhibits reactivity as a result of decomposition.

The binder polymer having such a crosslinking functional group is able to form a crosslinking structure upon heating after coating.

For the purpose of imparting antiglare properties, the light scattering layer contains a mat particle which is larger than a filler particle and which has an average particle diameter of from 1 to 10 μm, and preferably form 1.5 to 7.0 μm, for example, particles of an inorganic compound and resin particles.

Specific examples of the mat particle which is preferable include particles of an inorganic compound (for example, silica particles, TiO₂ particles, etc.) and resin particles (for example, acrylic particles, crosslinked acrylic particles, polystyrene particles, crosslinked styrene particles, melamine resin particles, benzoguanamine resin particles, etc.). Of these, crosslinked styrene particles, crosslinked acrylic particles, crosslinked acrylic-styrene particles, or silica particles are especially preferable. As to the shape of the mat particle, any of a spherical shape or an amorphous shape can be used.

Also, two or more kinds of mat particles having a different particle diameter from each other may be used in combination. It is possible to impart antiglare properties by a mat particle having a larger particle diameter and to impart a separate optical characteristic by a mat particle having a smaller particle diameter.

Furthermore, as to the particle size distribution of the mat particle, a monodispersed particle is the most preferable, and it is favorable that the particle diameter of the respective particles is identical as far as possible. For example, when a particle having a particle diameter larger than the average particle diameter by 20% or more is defined as a coarse particle, a proportion of this coarse particle is preferably not more than 1%, more preferably not more than 0.1%, and still more preferably not more than 0.01% relative to the whole of particles. A mat particle having such particle size distribution can be obtained by classification after a usual synthesis reaction. By increasing a number of classification or strengthening its degree, it is possible to obtain a mat agent having more preferred particle size distribution.

The mat particle is contained in the light scattering layer such that the amount of the mat particle in the formed light scattering layer is preferably from 10 to 1,000 mg/m², and more preferably from 100 to 700 mg/m².

The particle size distribution of the mat particle is measured by the Coulter counter method, and the measured distribution is reduced into particle number distribution.

In order to enhance the refractive index of the layer, it is preferable that the light scattering layer contains, in addition to the mat particle, an inorganic filler which is composed of an oxide of at least one metal selected among titanium, zirconium, aluminum, indium, zinc, tin, and antimony and which has an average particle diameter of not more than 0.2 μm, preferably not more than 0.1 μm, and more preferably not more than 0.06 μm.

Inversely, in order to make a difference in the refractive index from the mat particle large, it is also preferable that an oxide of silicon is used in the light scattering layer using a high refractive index mat particle for the purpose of keeping the refractive index of the layer low. A preferred particle diameter is the same as in the foregoing inorganic filler.

Specific examples of the inorganic filler which is used in the light scattering layer include TiO₂, ZrO₂, Al₂O₃, In₂O₃, ZnO, SnO₂, Sb₂O₃, ITO, and SiO₂. Of these, TiO₂ and ZrO₂ are especially preferable in view of realizing a high refractive index. It is also preferable that the surface of the inorganic filler is subjected to a silane coupling treatment or a titanium coupling treatment. A surface treating agent having a functional group capable of reacting with a binder species on the filler surface is preferably used.

An addition amount of such an inorganic filler is preferably from 10 to 90%, more preferably from 20 to 80%, and especially preferably from 30 to 75% of the total mass of the light scattering layer.

Incidentally, since such a filler has a particle diameter thoroughly smaller than the wavelength of light, scattering is not generated, and a dispersion having the filler dispersed in a binder polymer behaviors as an optically uniform substance.

A refractive index of a bulk of the mixture of the binder and the inorganic filler of the light scattering layer is preferably from 1.48 to 2.00, and more preferably from 1.50 to 1.80. In order to make the refractive index fall within the foregoing range, it would be better that the kind and amount of each of the binder and the inorganic filler are properly chosen. How to choose can be empirically known with ease in advance.

In particular, in order to ensure uniformity in surface properties against coating unevenness, drying unevenness, point defect, etc., it is preferable that any one or both of a fluorine based surfactant and a silicone based surfactant are contained in a coating composition for forming an antiglare layer. In particular, a fluorine based surfactant is preferably used because it reveals an effect for improving planar failure of the antireflection film of the invention, such as coating unevenness, drying unevenness, and point defect, in a smaller addition amount. This is made for the purpose of increasing the productivity by bringing high-speed coating adaptability while increasing the uniformity in surface properties.

In order that the optical film of the invention may satisfy a relation of |Rth|≦20, it is preferable that the light scattering layer satisfies a relation of |Rth|≦2.

Next, the antireflection layer in which a middle refractive index layer, a high refractive index layer, and a low refractive index layer are stacked in this order on the optical film of the invention is hereunder described.

An antireflection film composed of a layer configuration in which at least a middle refractive index layer, a high refractive index layer, and a low refractive index layer (outermost layer) are stacked in this order on a substrate (the optical film of the invention) is designed so as to have a refractive index satisfying the following relationship.

(Refractive index of high refractive index layer)>(Refractive index of middle refractive index layer)>(Refractive index of transparent support)>(Refractive index of low refractive index layer)

Also, a hard coat layer may be provided between the optical film of the invention and the middle refractive index layer. Furthermore, the configuration may be composed of a middle refractive index hard coat layer, a high refractive index layer, and a low refractive index layer (see, for example, JP-A-8-122504, JP-A-8-110401, JP-A-10-300902, JP-A-2002-243906, JP-A-2000-111706, etc.). Also, other function may be imparted to each of the layers. For example, there is exemplified a configuration in which an antifouling low refractive index layer and an antistatic high refractive index layer are stacked (those described in, for example, JP-A-10-206603, JP-A-2002-243906, etc.).

Also, the strength of the antireflection film is preferably H or more, more preferably 2H or more, and most preferably 3H or more in a pencil hardness test in conformity with JIS K5400.

### (High Refractive Index Layer and Middle Refractive Index Layer)

The layer having a high refractive index of the antireflection film is composed of a curable film containing at least a high refractive index inorganic compound superfine particle having an average particle diameter of not more than 100 nm and a matrix binder.

Examples of the inorganic compound superfine particle having a high refractive index include inorganic compounds having a refractive index of 1.65 or more. Of these, those having a refractive index of 1.9 or more are preferable. Examples thereof include oxides of Ti, Zn, Sb, Sn, Zr, Ce, Ta, La, In, etc. and composite oxides containing such a metal atom.

Examples of a method for obtaining such a superfine particle include a treatment of the particle surface with a surface treating agent (for example, a treatment with a silane coupling agent described in JP-A-11-295503, JP-A-11-153703, and JP-A-2000-9908; and a treatment with an anionic compound or an organometallic coupling agent described in JP-A-2001-310432, etc.); employment of a core/shell structure in which a high refractive index particle is a core (see, for example, JP-A-2001-166104, JP-A-2001-310432, etc.); and combined use with a specified dispersant (see, for example, JP-A-11-153703, U.S. Pat. Nos. 6,210,858, JP-A-2002-2776069, etc.).

Examples of a material which forms the matrix include conventionally known thermoplastic resins and curable resin films.

Furthermore, at least one composition selected from compositions containing a polyfunctional compound having at least two radical polymerizable and/or cationic polymerizable groups and compositions containing a hydrolyzable group-containing organometallic compound and a partial condensate thereof is preferable. Examples thereof include compositions described in, for example, JP-A-2000-47004, JP-A-2001-315242, JP-A-2001-31871, JP-A-2001-296401, etc.

Also, a curable film obtained from a colloidal metal oxide obtainable from a hydrolysis condensate of a metal alkoxide and a metal alkoxide composition is preferable. Such is described in, for example, JP-A-2001-293818, etc.

A refractive index of the high refractive index layer is generally from 1.70 to 2.20. A thickness of the high refractive index layer is preferably from 5 nm to 10 μm, and more preferably from 10 nm to 1 μm.

The middle refractive index layer is adjusted so as to have a refractive index which is a value laying between the refractive index of the low refractive index layer and the refractive index of the high refractive index layer. The refractive index of the middle refractive index layer is preferably from 1.50 to 1.70. Also, a thickness of the middle refractive index layer is preferably from 5 nm to 10 μm, and more preferably from 10 nm to 1 μm.

### (Low Refractive Index Layer)

The low refractive index layer is formed upon being successively staked on the high refractive index layer. A refractive index of the low refractive index layer is from 1.20 to 1.55, and preferably from 1.30 to 1.50.

It is preferable that the low refractive index layer is constructed as an outermost layer having resistance to scuffing and antifouling properties. As a measure for largely enhancing the resistance to scuffing, it is effective to impart slipperiness to the surface. A conventionally known measure of a thin film layer by introducing silicone, introducing fluorine or the like can be applied.

A refractive index of the fluorine-containing compound is preferably from 1.35 to 1.50, and more preferably from 1.36 to 1.47. Also, the fluorine-containing compound is preferably a compound having a crosslinking or polymerizable functional group containing a fluorine atom in an amount in the range of from 35 to 80% by mass.

Examples thereof include compounds described in, for example, paragraphs [0018] to of JP-A-9-222503, paragraphs [0019] to [0030] of JP-A-11-38202, paragraphs [0027] to [0028] of JP-A-2001-40284, JP-A-2000-284102, etc.

The silicone compound is a compound having a polysiloxane structure, and it is preferably a compound having a curable functional group or a polymerizable functional group in a polymer chain thereof and having a bridged structure in the film. Examples thereof include reactive silicones (for example, SILAPLANE (manufactured by Chisso Corporation), etc.) and polysiloxanes having a silanol group in both terminals thereof (see, for example, JP-A-11-258403, etc.).

The crosslinking or polymerization reaction of a fluorine-containing and/or siloxane polymer having a crosslinking or polymerizable group can be carried out by coating a coating composition for forming an outermost layer, which contains a polymerization initiator, a sensitizer, and so on and simultaneously with or after coating, irradiating light or heating.

Also, a sol-gel cured film obtained by curing an organometallic compound such as silane coupling agents and a silane coupling agent containing a specified fluorine-containing hydrocarbon group in the co-presence of a catalyst is preferable.

Examples of such a sol-gel cured film include polyfluoroalkyl group-containing silane compounds or partial hydrolysis condensates thereof (for example, compounds described in JP-A-58-142958, JP-A-58-147483, JP-A-58-147484, JP-A-9-157582, JP-A-11-106704, etc.); and silyl compounds containing a poly(perfluoroalkyl ether) group which is a fluorine-containing long chain group (for example, compounds described in JP-A-2000-117902, JP-A-2001-48590, and JP-A-2002-53804, etc.).

The low refractive index layer can contain a filler (for example, low refractive index inorganic compounds having an average particle diameter of primary particle of from 1 to 150 nm, for example, silicon dioxide (silica) and fluorine-containing particles (for example, magnesium fluoride, calcium fluoride, barium fluoride, etc.), organic fine particles described in paragraphs [0020] to [0038] of JP-A-11-3820, etc.), a silane coupling agent, a lubricant, a surfactant, etc. as additives other than the foregoing additives.

In the case where the low refractive index layer is disposed beneath the outermost layer, the low refractive index layer may be formed by a vapor phase method (for example, a vacuum vapor deposition method, a sputtering method, an ion plating method, a plasma CVD method, etc.). A coating method is preferable in view of the fact that the low refractive index layer can be produced at low costs.

A film thickness of the low refractive index layer is preferably from 30 to 200 nm, more preferably from 50 to 150 nm, and most preferably from 60 to 120 nm.

### (Other Layers of Antireflection Layer)

Furthermore, a hard coat layer, a forward scattering layer, a primer layer, an antistatic layer, an under coat layer, a protective layer, etc. may be provided.

### <Polarizing Plate>

A polarizing plate according to an exemplary embodiment of the invention has a polarizer and a protective film and contains the optical film of the invention as the protective film. Though the protective film is provided at least on the outer surface of the polarizer (the surface on the counter side against the surface opposing a liquid crystal cell of the polarizer when disposed in a liquid crystal display device), it is preferable that the protective film is provided on the both surfaces of the polarizer. It is preferable that the optical film of the invention is used as the protective film on the outer surface.

As the polarizer of the polarizing plate, known protective films can be used without particular limitations. Examples thereof include an iodine based polarizer, a dye based polarizer using a dichroic dye, and a polyene based polarizer. In general, the iodine based polarizer and the dye based polarizer are manufactured by using a polyvinyl alcohol based film. As a thickness of the polarizer, the thicknesses which are usually adopted can be adopted without particular limitations.

As the polarizer of the polarizing plate, in addition to the optical film of the invention, those exemplified above as the transparent support of the optical film of the invention can be used.

As the polarizing plate which is used for the 3D display, there is exemplified a patterning retardation layer having the optical film of the invention as the protective film, in which the optically anisotropic layer of the optical film of the invention includes a plurality of regions where directions of the slow axes are different from each other.

As the patterning retardation layer, there is exemplified a patterning retardation layer formed in such a manner that plural right eye retardation regions and plural left eye retardation regions are, for example, alternately formed in every line and patterned so as to produce the right eye retardation regions and the left eye retardation regions, as described previously. Patterning retardation layers described in JP-A-2005-215326 and JP-A-2009-223001 can also be used.

### <Liquid Crystal Display Device>

A liquid crystal display device according to an exemplary embodiment of the invention has a polarizing plate using the optical film of the invention.

As an embodiment of the liquid crystal display device of the invention, a 3D liquid crystal display device is exemplified. The liquid crystal display device is a liquid crystal display device including a pair of substrates disposed opposing to each other, at least one of which has an electrode; a liquid crystal layer between the pair of substrates; and a first polarizing plate disposed on the light source side and a second polarizing plate disposed on the viewing side, the polarizing plates being disposed interposing the liquid crystal layer therebetween and each having a polarizer and a protective film provided at least on the outer surface of the polarizer, wherein an image is viewed through a third polarizing plate existing on the viewing side of the second polarizing plate and having a polarizer and at least one protective film, and the protective film on the viewing side of the second polarizing plate is the optical film of the invention.

As the display mode of the liquid crystal display device, various display modes can be used. Examples thereof include a TN (twisted nematic) mode, an IPS (in-plane switching) mode, an FLC (ferroelectric liquid crystal) mode, an AFLC (anti-ferroelectric liquid crystal) mode, an OCB (optically compensatory bend) mode, an STN (super twisted nematic) mode, a VA (vertically aligned) mode, and an HAN (hybrid aligned nematic) mode.

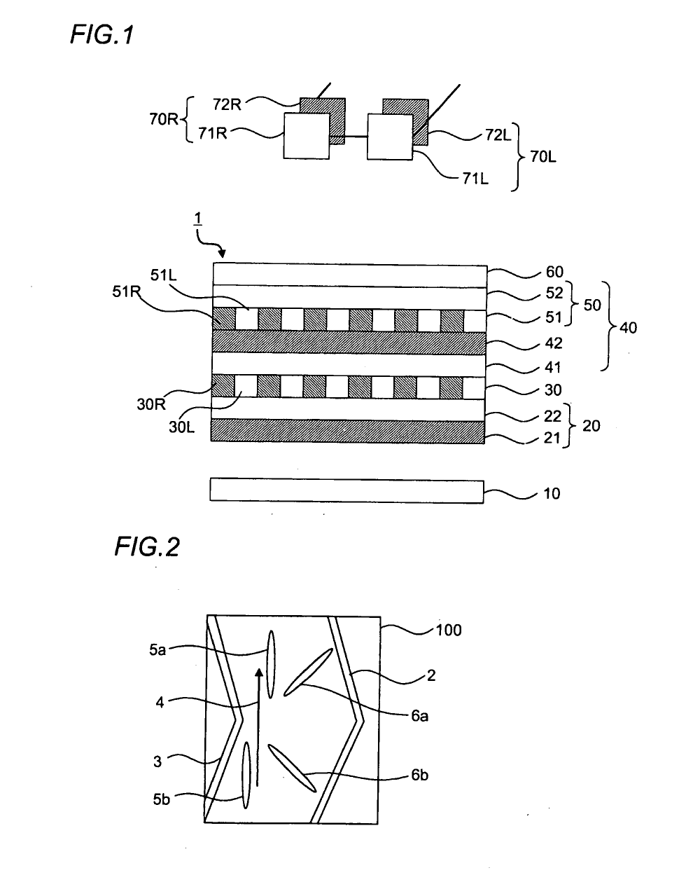

FIG. 1 schematically shows a configuration of an embodiment of a liquid crystal display device of the invention.

A liquid crystal displayer device 1 has a light source 10, a first polarizing plate 20, a liquid crystal cell 30, a second polarizing plate 40, and a surface film 60 in this order, and a 3D image is viewed through third polarizing plates 70L and 70R existing on the viewing side relative to the second polarizing plate 20.

The first polarizing plate 20 is composed of at least a polarizer 21 and an optically compensatory layer 22. The optically compensatory layer 22 is able to also serve as a protective film of the polarizer 21. A protective film may be provided on the light source-side surface of the polarizer 21.

The liquid crystal cell 30 has a configuration in which a left eye pixel 30L and a right eye pixel 30R are alternately disposed, and each pixel has a liquid crystal layer between a pair of substrates having an electrode.

The second polarizing plate 40 has a polarizer 42 and an optical film 50 of the invention on the outer surface (viewing-side surface) of the polarizer 42 and has an optically compensatory layer 41 on the surface of the polarizer 42 on the side of the liquid crystal cell 30. The optically compensatory layer 41 is able to also serve as a protective film of the polarizer 42.

The optically film 50 has a transparent support 52 and an optically anisotropic layer 51 having a λ/4 function. The optically anisotropic layer 51 forms a patterning retardation layer in which regions 51L and 51R having a different slow axis direction from each other are alternately disposed. The regions 51L and 51R are provided corresponding to the left eye pixel 30L and right eye pixel 30R of the liquid crystal cell 30, respectively. In the optical film 50 of the invention, changes in performance and size to be caused due to a humidity change or a temperature change are suppressed, and therefore, a correspondence relation between the regions 51L and 51R and the left eye pixel 30L and right eye pixel 30R is kept, and the generation of crosstalk is suppressed.

In the patterning retardation layer, the first region 51L and the second region 51R having a different polarization conversion function from each other are provided on plural first lines and plural second lines where image display panels are alternately repeated (for example, when the lines lie in the horizontal direction, the first region 51L and the second region 51R may be provided on odd-numbered lines and even-number lines in the horizontal direction; and whereas when the lines lie in the vertical direction, the first region 51L and the second region 51R may be provided on odd-numbered lines and even-number lines in the vertical direction. In the case of utilizing circular polarization for the display, it is preferable that a retardation of each of the first region 51L and the second region 51R is λ/4, and it is more preferable that slow axes of the first region 51L and the second rein 51R are orthogonal to each other.

In the case of utilizing circular polarization, when each of the first region 51L and the second region 51R has a retardation value of λ/4, a right eye image is displayed on the odd-numbered lines of the image display panel, and the slow axis of the odd-numbered line retardation region lies in the direction of 45°, it is preferable to dispose a λ/4 plate for each of a right glass and a left glass of polarized glasses, and specifically, the slow axis of the λ/4 plate of the right glass of the polarized glasses may be fixed at approximately 45°. Also, so far as the foregoing situation is concerned, similarly, when a left eye image is displayed on the even-numbered lines of the image display panel, and the slow axis of the even-numbered line retardation region lies in the direction of 135°, the slow axis of the left glass of polarized glasses may be specifically fixed at approximately 135°.

Furthermore, from the viewpoint that an image light is once outputted as circular polarization in the patterning retardation layer, and the polarized state is returned to an original state by the polarized glasses, in the case of the foregoing example, it is preferable that the angle of the slow axis to be fixed by the right glass is precisely close to 45° in the horizontal direction as far as possible. Also, it is preferable of the angle of the slow axis to be fixed by the left glass is precisely close to 135° (or −45° in the horizontal direction as far as possible.

Also, for example, in the case where the image display panel is a liquid crystal display panel, it is preferable that the absorption axis direction of the front side polarizing plate of the liquid crystal display panel is usually the horizontal direction, and the absorption axis of the linear polarizer of the polarized glasses is a direction orthogonal to the absorption axis direction of the front side polarizing plate; and it is more preferable that the absorption axis of the linear polarizer of the polarized glasses is the perpendicular direction.

Also, in view of efficiency of the polarization conversion, it is preferable that the absorption axis direction of the front side polarizing plate of the liquid crystal display panel forms an angle of 45° with each of the slow axes of the odd-numbered retardation region and the even-numbered retardation region of the patterning retardation layer.

Incidentally, preferred dispositions of such polarized glasses, patterning retardation layers and liquid crystal display devices are disclosed in, for example, JP-A-2004-170693.

On the uppermost surface of the second polarizing plate 40, the surface film 60 such as an antireflection film is provided.

The third polarizing plate is composed of the left eye polarizing plate 70L and the right eye polarizing plate 70R, which have polarizers 72L and 72R and λ/4 plates 71L and 71R, respectively. The third polarizing plate is hereunder further described.

### <Third Polarizing Plate>

In particular, in order to allow a viewer to recognize a stereoscopic image which is called a “3D image”, it is preferable to recognize an image through a polarizing plate having a glass shape.

### <Polarized Glasses>

It is preferable that an image display system of the invention includes polarized glasses in which slow axes of a right glass and a left glass are orthogonal to each other and is configured in such a manner that a right eye image light outputted from one of the first region and the second region of the patterning retardation layer transmits through the right glass and is shielded by the left glass, whereas a left eye image light outputted from the remaining one of the first region and the second region of the patterning retardation layer transmits through the left glass and is shielded by the right glass.

As a matter of course, the polarized glasses include a retardation functional layer disposed corresponding to the patterning retardation and a linear polarizer, thereby forming polarized glasses. Incidentally, other members having a function equal to the linear polarizer may be used.

As examples of the polarized glasses, there can be exemplified those described in JP-A-2004-170693 and an attachment of ZM-M220W, manufactured by Zalman Tech Co., Ltd. as a commercially available product.

### <Retardation>

Retardations Re and Rth of a layer having a film thickness d are defined according to the following expressions.

Re=(nx−ny)×d

Rth=((nx+ny)/2−nz)×d (expression (2) as described later)

In the foregoing expressions, nx represents a refractive index in the slow axis direction in the plane; ny represents a refractive index in the direction orthogonal to nx in the plane; and nz represents a refractive index in the film thickness direction orthogonal to nx and ny.

### <Measurement Method>

In this specification, Re (λ) and Rth (λ) represent an in-plane retardation and a retardation in the thickness direction at a wavelength of λ, respectively. The Re (λ) is measured by making light having a wavelength of λ nm incident in a normal direction of the film in KOBRA 21ADH or WR (manufactured by Oji Scientific Instruments). In selecting the measuring wavelength λ nm, the measurement can be achieved by manually exchanging a wavelength selective filter or converting a measured value with a program, etc.

In the case where the film to be measured is expressed by a uniaxial or biaxial ellipsoid, the Rth (λ) is calculated in the following manner.

The Rth (λ) is calculated by KOBRA 21ADH or WR on the basis of six measured Re (λ) values, an assumed value of the average refractive index, and an inputted film thickness. The retardation Re (λ) values are measured such that light having a wavelength of λ nm is made incident to the film from six directions tilted at 0° to 50° at intervals of 10° to the film normal line, using an in-plane slow axis (detected by KOBRA 21ADH or WR) as a tilt axis (rotation axis) (when the film has no slow axis, an arbitrary in-plane direction is used as the rotation axis).

In the foregoing, when a retardation value measured using the in-plane slow axis as the rotation axis is zero at a certain tilt angle to the normal line, the positive sign of a retardation value at a tilt angle larger than the foregoing certain tilt angle is converted to a negative sign, and the negative retardation value is then used in the calculation by KOBRA 21ADH or WR.

Incidentally, the Rth can also be calculated by the following expressions (11) and (2) on the basis of an assumed value of the average refractive index, an inputted thickness value, and two retardation values measured in two tilt directions, using the slow axis as the tilt axis (the rotation axis) (when the film has no slow axis, an arbitrary in-plane direction is used as the rotation axis).

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( - θ )}{nx} ) )} \qquad Expression ( 11 )$$

In the foregoing expression (11), Re (θ) represents a retardation value in a direction tilted at an angle 0 to the film normal line.

In the expression (11), nx represents a refractive index in the slow axis direction in the plane; ny represents a refractive index in the direction orthogonal to nx in the plane; nz represents a refractive index in the film thickness direction orthogonal to nx and ny; and d represents a film thickness.

Rth=((nx+ny)/2−nz)×d Expression (2)

In the expression (2), nx represents a refractive index in the slow axis direction in the plane; ny represents a refractive index in the direction orthogonal to nx in the plane; nz represents a refractive index in the film thickness direction orthogonal to nx and ny; and d represents a film thickness.

In the case where the film to be measured cannot be expressed in terms of a uniaxial or biaxial refractive index ellipsoid, and thus has no so-called optic axes, the Rth (λ) is calculated in the following manner.

The Rth(λ) is calculated by KOBRA 21ADH or WR on the basis of eleven measured Re (λ) values, an assumed value of the average refractive index, and an inputted film thickness value. The retardation Re (λ) values are measured such that light having a wavelength of λ nm is made incident to the film from eleven directions tilted at −50° to +50° at intervals of 10° to the film normal line, using an in-plane slow axis (detected by KOBRA 21ADH or WR) as a tilt axis (rotation axis).

In the foregoing measurements, as the assumed values of the average refractive indices, those described in Polymer Handbook (JOHN WILEY & SONS, INC.) and catalogs of various optical films can be used. Unknown average refractive indices may be obtained by measurement using an Abbe refractometer. The average refractive indices of major optical film materials are as follows: cellulose acylate (1.48), cycloolefin polymer (1.52), polycarbonate (1.59), polymethyl methacrylate (1.49), and polystyrene (1.59). The above values of nx, ny, and nz are calculated by KOBRA 21ADH or WR from the inputted assumed average refractive index and film thickness value. Nz is further calculated from thus obtained nx, ny, and nz according to an expression: Nz=(nx−nz)/(nx−ny).

### EXAMPLES

The invention is more specifically described below with reference to the Examples. Materials, reagents, amounts of substances and ratios thereof, operations, and the like shown in the following Examples can be appropriately changed unless deviating from the gist of the invention. In consequence, it should be construed that the scope of the invention is not limited to the following specific examples.

The following Examples are concerned with the fabrication of a second polarizing plate which among three polarizing plates configuring the liquid crystal display device of the invention, is one of a pair of polarizing plates to be disposed on the both sides of a liquid crystal cell and which is the polarizing plate on the viewer's side.

### Example 1

### (Fabrication of Cellulose Acylate Film 001)

A cellulose acylate solution (dope) having the following composition was prepared.

| | |
|---|---|
| Methylene chloride: | 435 parts by mass |
| Methanol: | 65 parts by mass |
| Cellulose acylate benzoate (CBZ) (acetyl substitution | 100 parts by mass |
| degree: 2.45, benzoyl substitution degree: 0.55, mass | |
| average molecular weight: 180,000): | |
| Silicon dioxide fine particle (average particle diameter: | 0.25 parts by mass |
| 20 nm, Moh's hardness: about 7): | |

The obtained dope was cast on a film formation band, dried at room temperature for one minute, and then dried at 45° C. for 5 minutes. A residual amount of the solvent after drying was 30% by mass. A cellulose acylate film was stripped off from the band, dried at 100° C. for 10 minutes, and then dried at 130° C. for 20 minutes, thereby obtaining a cellulose acylate film 001. A residual amount of the solvent was 0.1% by mass. A film thickness was 45 μm.

### (Fabrication of Cellulose Acylate Films 002 to 018)

Cellulose acylate films 002 to 017 were fabricated in the same method as that in the cellulose acylate film 001, except for changing the kind of the cellulose acylate and the additive as shown in Table 5.

Also, ZEONOR, manufactured by Zeon Corporation was prepared as a transparent film 018.

### <Evaluation of Films 001 to 018>

### <Re and Rth>

As to the evaluation of the film samples, a part of each of the above-obtained film samples was prepared. As to the retardation values, Re and Rth against light having a wavelength of 550 nm at 25° C. and 60% RH were measured using KOBRA 21ADH (manufactured by Oji Scientific Instruments). The results are shown in Table 5.

<ΔRth (25° C. 30% RH−25° C. 80% RH)>

The same sample as described above was used; the interior of a room for measuring the film was regulated at 25° C. and 30% RH and at 25° C. and 80%, respectively; and the Rth was measured using KOBRA 21ADH. An absolute value of a difference between Rth at 25° C. and 30% RH and Rth at 25° C. and 80% was defined as ΔRth (25° C. 30% RH−25° C 80% RH). The results are shown in Table 5.

### <Evaluation of Linear Thermal Expansion Coefficient>

A part of each of the above-obtained film samples was prepared and cut out into a film having a width of 3 mm and a length of 35 mm (in the measurement direction). The sample was subjected to humidity control under an environment at 25° C. and 60% RH for 3 hours or more. Subsequently, the sample was measured with TMA (thermal mechanical analyzer, manufactured by TA Instruments) at a chuck-to-chuck distance of 25.4 mm under a temperature rise condition of from 30 to 100° C. (at a rate of 20° C./min) at a tension of 0.04 N; and a value ΔL (80−40) (mm) obtained by subtracting a chuck-to-chuck size of the sample at 40° C. from a chuck-to-chuck size at 80° C. was determined, from which was then calculated ΔL (80−40)/(25.4×40), thereby obtaining a linear thermal expansion coefficient.

TABLE 5

| | Cellulose acylate | | | | | | | | Linear |
|---|---|---|---|---|---|---|---|---|---|
| | | Mass | | | | | | | thermal |
| | | average | Additive (1) | Additive (2) | Film | | | | expansion |
| | Substituent (degree | molecular | (% by mass vs. | (% by mass vs. | thickness | Re | Rth | ΔRth | coefficient |
| Film | of substitution) | weight | cellulose acylate) | cellulose acylate) | [μm] | [nm] | [nm] | [nm] | [ppm/° C.] |
| 001 | Acetyl group (2.45) | 180000 | — | — | 45 | 0 | −75 | 15 | 51 |
| | Benzoyl group (0.55) | | | | | | | | |
| 002 | Acetyl group (2.45) | 180000 | TPP/BDP (8/4) | — | 60 | 0 | −75 | 9 | 63 |
| | Benzoyl group (0.55) | | | | | | | | |
| 003 | Acetyl group (2.45) | 180000 | TPP/BDP (4/2) | — | 53 | 0 | −75 | 12 | 57 |
| | Benzoyl group (0.55) | | | | | | | | |
| 004 | Acetyl group (2.94) | 220000 | Ester oligomer 1 (50) | — | 40 | 0 | −75 | 2 | 50 |
| 005 | Acetyl group (2.94) | 220000 | Ester oligomer 1 (55) | — | 38 | 0 | −76 | 2 | 50 |
| 006 | Acetyl group (2.94) | 220000 | Ester oligomer 1 (60) | — | 36 | 0 | −77 | 2 | 50 |
| 007 | Acetyl group (2.94) | 220000 | Ester oligomer 2 (50) | — | 40 | 0 | −75 | 2 | 50 |
| 008 | Acetyl group (2.94) | 220000 | Ester oligomer 3 (50) | — | 39 | 0 | −75 | 3 | 50 |
| 009 | Acetyl group (2.94) | 220000 | Ester oligomer 4 (50) | — | 38 | 0 | −75 | 3 | 50 |
| 010 | Acetyl group (2.94) | 220000 | Ester oligomer 1 (50) | Compound A (2) | 36 | 0 | −74 | 1 | 50 |
| 011 | Acetyl group (2.94) | 220000 | Ester oligomer 1 (50) | Compound A (4) | 34 | 0 | −72 | 1 | 50 |
| 012 | Acetyl group (2.86) | 220000 | Ester oligomer 1 (50) | — | 50 | 0 | −75 | 2 | 50 |
| 013 | Acetyl group (2.02) | 150000 | Ester oligomer 1 (50) | — | 40 | 0 | −75 | 2 | 47 |
| | Butyl group (0.70) | | | | | | | | |
| 014 | Acetyl group (2.11) | 150000 | Ester oligomer 1 (50) | — | 40 | 0 | −75 | 2 | 47 |
| | Butyl group (0.63) | | | | | | | | |
| 015 | Cellulose acylate 1/ | 220000/ | Ester oligomer 1 (50) | — | 40 | 0 | −72 | 1 | 47 |
| | Cellulose acylate 2 | 150000 | | | | | | | |
| | (mixing ratio: 80/20 by | | | | | | | | |
| | mass) | | | | | | | | |
| 016 | Acetyl group (2.86) | 220000 | TPP/BDP (8/4) | — | 80 | 4 | 46 | 24 | 50 |
| 017 | Acetyl group (2.94) | 220000 | — | — | 75 | 0 | −75 | 26 | 48 |
| 018 | ZEONOR | — | — | — | 100 | 5 | 5 | 0 | 66 |

Compound A: 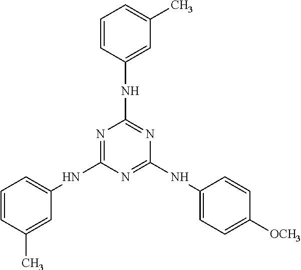
Cellulose acylate 1: Acetyl substitution degree: 2.94, mass average molecular weight: 220,000
Cellulose acylate 2: Acetyl substitution degree: 2.02, butyryl substitution degree: 0.83, mass average molecular weight: 150,000

Other materials other than the cellulose acylate, which were used for each film, are shown below.

TPP: Triphenyl phosphate

BDP: Bisphenol A bis-diphenyl phosphate

Each of the ester oligomers 1 to 4 is a polyester based oligomer obtained by a polycondensation reaction of a dicarboxylic acid and a diol as shown in the following Table 6. The both terminals of the molecule are sealed with an acetyl group.

TABLE 6

| | AA | PA | EG | PG | Terminal structure |
|---|---|---|---|---|---|
| Ester oligomer 1 | 100 | 0 | 100 | 0 | Acetyl group |
| Ester oligomer 2 | 100 | 0 | 75 | 25 | Acetyl group |
| Ester oligomer 3 | 100 | 0 | 50 | 50 | Acetyl group |
| Ester oligomer 4 | 50 | 50 | 100 | 0 | Acetyl group |

In Table 6, AA represents adipic acid (carbon number: 6); PA represents phthalic acid (carbon number: 10); EG represents ethylene glycol (carbon number: 2); and PG represents 1,2-propylene glycol (carbon number: 3). The numerals in the table represent a molar ratio.

### <<Patterning Retardation Layer>>

A patterning retardation layer was fabricated on a glass substrate at Re (550) of 138 nm and Rth (550) of 74 nm with reference to JP-A-2009-223001, such that the direction of a slow axis laid at 45° and −45°, respectively in a period of 100 μm. This was transferred onto each of the above-fabricated transparent films 001 to 018, thereby fabricating optical films 1001 to 1018.

Re and Rth of the whole of the optical film were measured using KOBRA 21ADH (manufactured by Oji Scientific Instruments). Incidentally, each of Re and Rth was measured in terms of a value at a wavelength of 550 nm at 25° C. and 60% RH. The measurement results are shown in Table 7.

### <Evaluation>

A pattern retardation plate used in a 3D monitor of a circular polarized glass system (manufactured by Zalman Tech Co., Ltd.) was stripped off, and each of the optical films 1001 to 1018 was stuck thereto. At that time, each of the optical films 1001 to 1018 was stuck such that its patterning retardation layer was located on the polarizer side.

Similarly, a spectral radiance meter (SR-3, manufactured by Topcon Corporation) was placed at a position through the glasses, and a luminance was measured when each of the optical films was stuck.

As to the optical films 1001 to 1015, it was confirmed that the luminance was enhanced by 5% or more as compared with that in a configuration before stripping off the used pattern retardation plate.

### <Evaluation of Crosstalk>

### (At the Initial Stage)

A pattern retardation plate used in a 3D monitor of a circular polarized glass system (manufactured by Zalman Tech Co., Ltd.) was stripped off, and each of the optical films 1001 to 1018 was stuck thereto. The 3D monitor was subjected to continuous lighting for 48 hours at 25° C. and 60% RH; thereafter, a right eye pixel was allowed to display a white pattern, whereas a left dye pixel was allowed to display a black pattern; a spectral radiance meter (SR-3, manufactured by Topcon Corporation) was placed at an eye position, thereby measuring a luminance through circular polarized glasses for right eye/left eye. (At that time, the luminance is defined as Y_RR and Y_RL, respectively.)

A degree of crosstalk was defined as CRO=(YRR−YRL)/(YRR+YRL).

When CRO just after lighting was defined as CRO_{—}0, and CRO after lighting for 48 hours was defined as CRO_{—}48, an index of CRO_{—}48/CRO_{—}0 in the case of using each of the optical films 1001 to 1018 was calculated and evaluated according to the following criteria.

A: CRO_{—}48/CRO_{—}0 is 95% or more.

B: CRO_{—}48/CRO_{—}0 is from 86 to 94%.

C: CRO_{—}48/CRO_{—}0 is not more than 85%.

Thereafter, the colors of the left and right pixels were exchanged, thereby allowing the right eye pixel to display a black pattern and allowing the left eye pixel to display a white pattern, and the same evaluation was carried out. As a result, equal values were revealed. (Low-humidity environment and high-temperature environment)

Also, indices of CRO_{—}48/CRO_{—}0 at 25° C. and 10% RH and at 45° C. and 60% RH were calculated in the same manner and evaluated according to the foregoing criteria.

The evaluation results are shown in Table 7.

TABLE 7

| | | | At the initial | Low-humidity | High-temperature | |
|---|---|---|---|---|---|---|
| | Retardation of | | stage | environment | environment | |
| | optical film | | (25° C. and | (25° C. and | (45° C. and | |
| Optical | Re | Rth | 60% RH) | 10% RH) | 60% RH) | |
| film | [nm] | [nm] | Crosstalk | | | |
| 1001 | 138 | −1 | A | B | A | Invention |
| 1002 | 138 | −1 | A | B | B | Invention |
| 1003 | 138 | −1 | A | B | B | Invention |
| 1004 | 138 | −1 | A | A | A | Invention |
| 1005 | 138 | −2 | A | A | A | Invention |
| 1006 | 138 | −3 | A | A | A | Invention |
| 1007 | 138 | −1 | A | A | A | Invention |
| 1008 | 138 | −1 | A | A | A | Invention |
| 1009 | 138 | −1 | A | A | A | Invention |
| 1010 | 138 | 0 | A | A | A | Invention |
| 1011 | 138 | 2 | A | A | A | Invention |
| 1012 | 138 | −1 | A | A | A | Invention |
| 1013 | 138 | −1 | A | A | A | Invention |
| 1014 | 138 | −1 | A | A | A | Invention |
| 1015 | 138 | 2 | A | A | A | Invention |
| 1016 | 142 | 120 | C | C | A | Comparison |
| 1017 | 138 | −1 | A | C | A | Comparison |
| 1018 | 143 | 79 | B | B | C | Comparison |

As shown in Table 7, in the 3D monitors using the optical film of the invention, the crosstalk is suppressed in average under a variety of environments.

### Example 2

### (Fabrication of Cellulose Acetate Film 101)

A cellulose acetate solution having the following composition was prepared.

TABLE 8
[Composition of cellulose acetate solution]

| | |
|---|---|
| Cellulose acetate (degree of acetylation: 60.9%): | 100 parts by mass |
| Triphenyl phosphate (plasticizer): | 10.0 parts by mass |
| Biphenyl diphenyl phosphate (plasticizer): | 5.0 parts by mass |
| Methylene chloride (first solvent): | 565.6 parts by mass |
| Methanol (second solvent): | 49.2 parts by mass |
| Retardation controlling agent: | 1.97 parts by mass |
| Silica fine particle (20 nm): | 0.05 parts by mass |

The following compound was used as the retardation controlling agent.

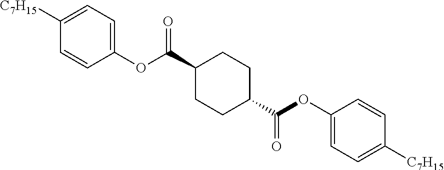

A spectrum in an ultraviolet/visible region (UV-vis) of this retardation controlling agent was measured in the same manner as that described above. As a result, a wavelength (λmax) for giving an absorption maximum was 230 nm, and at that time, an absorption coefficient (ε) was 16,000.

The obtained dope was cast on a film formation band, dried at room temperature for one minute, and then dried at 45° C. for 5 minutes. A residual amount of the solvent after drying was 30% by mass. A cellulose acetate film was stripped off from the band, dried at 100° C. for 10 minutes, and then dried at 130° C. for 20 minutes, thereby obtaining a cellulose acetate film 101. A residual amount of the solvent was 0.1% by mass. A film thickness was 130 μm.

### (Fabrication of Cellulose Acetate Film 102)

A cellulose acetate solution having the following composition was prepared.

TABLE 9
[Composition of cellulose acetate solution]

| | |
|---|---|
| Cellulose acetate (degree of acetylation: 60.9%): | 100 parts by mass |
| Triphenyl phosphate (plasticizer): | 10.0 parts by mass |
| Biphenyl diphenyl phosphate (plasticizer): | 5.0 parts by mass |
| Methylene chloride (first solvent): | 534.9 parts by mass |
| Methanol (second solvent): | 79.9 parts by mass |
| Retardation controlling agent: | 1.97 parts by mass |
| Silica fine particle (20 nm): | 0.05 parts by mass |

The same compound as that used in the cellulose acetate film 101 was used as the retardation controlling agent.

The obtained dope was cast on a film formation band, dried at room temperature for one minute, and then dried at 45° C. for 5 minutes. A residual amount of the solvent after drying was 30% by mass. A cellulose acetate film was stripped off from the band, dried at 100° C. for 10 minutes, and then dried at 130° C. for 20 minutes, thereby obtaining a cellulose acetate film 102. A residual amount of the solvent was 0.1% by mass. A film thickness was 130 μm.

### (Fabrication of Cellulose Acetate Film 103)

A cellulose acetate solution having the following composition was prepared.

TABLE 10
[Composition of cellulose acetate solution]

| | |
|---|---|
| Cellulose acetate (degree of acetylation: 60.9%): | 100 parts by mass |
| Triphenyl phosphate (plasticizer): | 10.0 parts by mass |
| Biphenyl diphenyl phosphate (plasticizer): | 5.0 parts by mass |
| Methylene chloride (first solvent): | 534.9 parts by mass |
| Methanol (second solvent): | 79.9 parts by mass |
| Retardation controlling agent: | 1.97 parts by mass |
| Silica fine particle (20 nm): | 0.05 parts by mass |

The following plate-shaped compound was used as the retardation controlling agent.

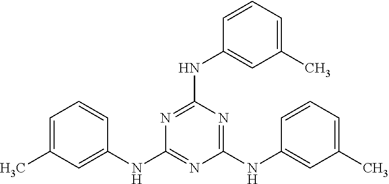

The obtained dope was cast on a film formation band, dried at room temperature for one minute, and then dried at 45° C. for 5 minutes. A residual amount of the solvent after drying was 30% by mass. A cellulose acetate film was stripped off from the band, dried at 100° C. for 10 minutes, and then dried at 130° C. for 20 minutes, thereby obtaining a cellulose acetate film 103. A residual amount of the solvent was 0.1% by mass. A film thickness was 130 μm.

### (Fabrication of Cellulose Acetate Film 104)

A cellulose acetate solution having the following composition was prepared.

TABLE 11
[Composition of cellulose acetate solution]

| | |
|---|---|
| Cellulose triacetate (degree of acetylation: 60.3 %): | 20 parts by mass |
| Methyl acetate: | 58 parts by mass |
| Acetone: | 5 parts by mass |
| Methanol: | 5 parts by mass |
| Ethanol: | 5 parts by mass |
| Butanol: | 5 parts by mass |
| Retardation controlling agent: | 1.0 part by mass |
| Plasticizer A (ditrimethylolpropane tetraacetate): | 1.2 parts by mass |
| Plasticizer B (triphenyl phosphate): | 1.2 parts by mass |
| UV agent a: (2,4-bis-(n-octylthio)-6-(4-hydroxy-3,5- | 0.2 parts by mass |
| di-tert-butylanilino)-1,3,5-triazine): | |
| UV agent b: (2(2′-hydroxy-3′,5′-di-tert-butylphenyl)- | 0.2 parts by mass |
| 5-chlorobenzotriazole): | |
| UV agent c: (2(2′-hydroxy-3′,5′-di-tert-amylphenyl)- | 0.2 parts by mass |
| 5-chlorobenzotriazole): | |
| C₁₂H₂₅OCH₂CH₂—P(═O)—(OK)₂ (release agent): | 0.02 parts by mass |
| Citric acid (release agent): | 0.02 parts by mass |
| Fine particle (silica (particle diameter: 20 nm), Moh's | 0.05 parts by mass |
| hardness: about 7): | |

The same compound as that used in the cellulose acetate film 101 was used as the retardation controlling agent. In the foregoing cellulose acetate, the acetyl group at the 6-position was substituted in a proportion larger than that of the acetyl group at each of the 2-position and the 3-position, The degree of acetylation at the 6-position, the 2-position and the 3-position was 20.5%, 19.9% and 19.9%, respectively.

The dissolution method is as follows (cooling dissolution method). That is, the foregoing compounds were gradually added to the solvent while thoroughly stirring, and the mixture was allowed to stand for swelling at room temperature (25° C.) for 3 hours. The obtained swollen mixture was cooled to −30° C. at a rate of −8° C./min while gently stirring. Thereafter, the resulting mixture was cooled to −70° C., and after elapsing 6 hours, the temperature was raised at a rate of +8° C./min. At the stage where solation of the contents proceeded to some extent, stirring of the contents was started. The temperature was raised to 50° C. to obtain a dope.

The obtained dope was cast on a film formation band, dried at room temperature for one minute, and then dried at 45° C. for 5 minutes. A residual amount of the solvent after drying was 30% by mass. A cellulose acetate film was stripped off from the band, dried at 100° C. for 10 minutes, and then dried at 130° C. for 20 minutes, thereby obtaining a cellulose acetate film 104. A residual amount of the solvent was 0.1% by mass. A film thickness was 130

Each of the fabricated cellulose acetate films 101 to 104 was measured with regards to the Re, Rth, ΔRth and linear thermal expansion coefficient in the same manners as those in Example 1. The measurement results are shown in Table 12.

TABLE 12

| | Film | | | | |
|---|---|---|---|---|---|
| | thickness | | | ΔRth | Linear thermal expansion |
| Film | [μ] | Re [nm] | Rth [nm] | [nm] | coefficient [ppm/° C.] |
| 101 | 115 | 140 | 100 | 18 | 50 |
| 102 | 115 | 140 | 100 | 19 | 50 |
| 103 | 115 | 140 | 100 | 17 | 50 |
| 104 | 115 | 140 | 100 | 19 | 50 |

### <Formation of Optically Anisotropic Layer Containing Rod-Shaped Liquid Crystalline Compound>

After saponifying the surface of each of the above-fabricated cellulose acetate films 101 to 104, an aligned film coating liquid having the following composition was continuously coated using a #14 wire bar. The coated composition was dried with a warm air at 60° C. for 60 seconds and further with a warm air at 100° C. for 120 seconds, thereby forming an aligned film.

[Composition of aligned film coating liquid]

| | | |
|---|---|---|
| Modified polyvinyl alcohol as described below: | 10 | parts by mass |
| Water: | 371 | parts by mass |
| Methanol: | 119 | parts by mass |
| Glutaraldehyde: | 0.5 | parts by mass |

Modified polyvinyl alcohol

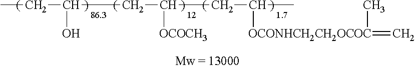

A coating liquid containing a rod-shaped liquid crystalline compound having the following composition was continuously coated on the above-fabricated aligned film using a #4.6 wire bar. A conveying rate of the film was set to 20 m/min. The solvent was dried in a step of continuously raising the temperature from room temperature to 90° C., and thereafter, the film was heated in a drying zone at 90° C. for 90 seconds, thereby aligning the rod-shaped liquid crystalline compound. Subsequently, the alignment of the liquid crystalline compound was fixed upon UV irradiation while keeping the temperature of the film at 60° C., thereby forming an optically anisotropic layer. Subsequently, the cellulose acetate film surface on the opposite side to the surface on which the optically anisotropic layer was formed was continuously saponified. There were thus fabricated optical films 1101 to 1104.

[Composition of coating liquid (S1) containing rod-shaped liquid
crystalline compound]

| | | |
|---|---|---|
| Rod-shaped liquid crystalline compound (I) as | 100 | parts by mass |
| described below: | | |
| Photopolymerization initiator (IRGACURE 907, | 3 | parts by mass |
| manufactured by Ciba-Geigy AG): | | |
| Sensitizer (KAYACURE DETX, manufactured by | 1 | part by mass |
| Nippon Kayaku Co., Ltd.): | | |
| Fluorine based polymer as described below: | 0.4 | parts by mass |
| Pyridinium salt as described below: | 1 | part by mass |
| Methyl ethyl ketone: | 172 | parts by mass |

Rod-shaped liquid crystalline compound (1) 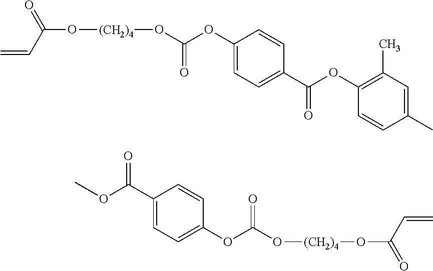
Fluorine based polymer 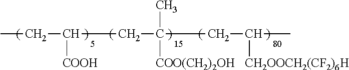
Pyridinium salt

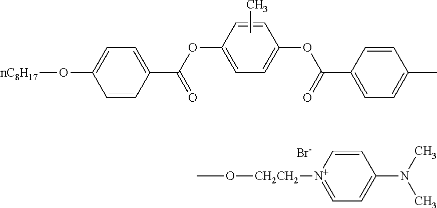

Only the optically anisotropic layer containing a rod-shaped liquid crystalline compound was stripped off from each of the fabricated optical films 1101 to 1104 and measured with regards to optical characteristics using an automatic birefringence analyzer (KOBRA 21ADH, manufactured by Oji Scientific Instruments). The mere optically anisotropic layer was measured at a wavelength of 550 nm at 25° C. and 60% RH, and as a result, it had an Re of 0 nm and an Rth of −90 nm. Also, the mere optically anisotropic layer was inclined by an arbitrary axis and measured for the Re. As a result, it could be confirmed that an optically anisotropic layer where a rod-shaped liquid crystal molecule was aligned substantially vertical against the film surface was formed.

The Re and Rth of the whole of the film of each of the optical films 1101 to 1104 at a wavelength of 550 nm at 25° C. and 60% RH were measured using KOBRA 21ADH (manufactured by Oji Scientific Instruments). All of the optical films 1101 to 1104 had an Re of 140 nm and an Rth of 10 nm.

### <Evaluation>

A pattern retardation plate used in a 3D monitor of a circular polarized glass system (manufactured by Zalman Tech Co., Ltd.) was stripped off, and each of the optical films 1101 to 1104 was stuck thereto. At that time, each of the optical films 1101 to 1104 was stuck such that its optically anisotropic layer was located on the polarizer side.

Similarly, a spectral radiance meter (SR-3, manufactured by Topcon Corporation) was placed at a position through the glasses, and a luminance was measured when each of the optical films 1101 to 1104 was stuck. It was confirmed that the luminance was enhanced by 5% or more as compared with that in a configuration before stripping off the used pattern retardation plate.

Also, the crosstalk was evaluated in the same manner as that in Example 1. The evaluation results are shown in Table 13.

TABLE 13

| | At the initial stage | Low-humidity | High-temperature |
|---|---|---|---|
| | (25° C. and 60% | environment | environment |
| | RH) | (25° C. and 10% RH) | (45° C. and 60% RH) |
| Film | Crosstalk | | |
| 1101 | A | B | A |
| 1102 | A | B | A |
| 1103 | A | B | A |
| 1104 | A | B | A |

### COMPARATIVE EXAMPLE

### (Preparation of Polymer Solution)

### (1) Cellulose Acylate:

The following cellulose acylate was heated for drying at 120° C. so as to have a water content of not more than 0.5% by mass, and thereafter, it was used in an amount of 20 parts by mass in total.

### Cellulose Acylate:

A powder of cellulose acetate having a degree of substitution of 2.86 was used. The cellulose acylate A had a viscosity average degree of polymerization of 300; an acetyl group substitution degree of 0.89; an acetone extraction content of 7% by mass; a mass average molecular weight/number average molecular weight ratio of 2.3; a water content of 0.2% by mass; a viscosity on a 6% by mass dichloromethane solution of 305 mPa·s; a residual acetic acid amount of not more than 0.1% by mass; a Ca content of 65 ppm; an Mg content of 26 ppm; an iron content of 0.8 ppm; a sulfuric acid ion content of 18 ppm; a yellow index of 1.9; and a free acetic acid amount of 47 ppm. The powder had an average particle size of 1.5 mm and a standard deviation of 0.5 mm.

### (2) Solvent:

A mixed solvent obtained by mixing dichloromethane and methanol in a ratio of 82/3. Incidentally, a water content of each of the solvents was not more than 0.2% by mass.

### (3) Additive:

The following additive was used.

Silicon dioxide fine particle (particle size: 20 nm, Moh's hardness: about 7) (0.08 parts by mass)

### (4) Dissolution:

In a 400-liter stainless steel-made dissolution tank equipped with a stirring blade, in the periphery of which cold water was circulated, the foregoing solvent and additive were charged, and the foregoing cellulose acylate was gradually added while stirring and dispersing. After completion of charging, the mixture was stirred at room temperature for 2 hours and swollen for 3 hours, followed by again performing stirring to obtain a cellulose acylate solution. Incidentally, for the stirring, a dissolver type eccentric stirring shaft running at a peripheral speed of 15 m/sec (shear stress: 5×10⁴ kgf/m/sec² [4.9×10⁵ N/m/sec²]) and a stirring shaft having an anchor blade at a center axis thereof and running at a peripheral speed of 1 m/sec (shear stress: 1×10⁴ kgf/m/sec² [9.8×10⁴ N/m/sec²]) were used. The swelling was carried out in such a manner that the high-speed stirring shaft was stopped, and the peripheral speed of the anchor blade-equipped stirring shaft was reduced to 0.5 m/sec.

The swollen mixture was transported from the tank, heated to 50° C. by a jacket-equipped conduit, and further heated to 90° C. under a pressure of 2 MPa, whereby it was completely dissolved. A heating time was 15 minutes. On that occasion, as the filter, the housing and the conduit to be exposed to high temperatures, those obtained by utilizing materials which were made of a hastelloy alloy and had excellent corrosion resistance, and equipped with a jacket for circulating a heat medium for heat insulation and heating were used.

Subsequently, the temperature was decreased to 36° C., thereby obtaining a cellulose acylate solution.

### (5) Filtration:

The obtained cellulose acylate solution was filtered with a filter paper (#63, manufactured by Toyo Roshi Kaisha, Ltd.) having an absolute filtration accuracy of 10 μm and further filtered with a sintered metal filter sheet (FH025, manufactured by Pall Corporation) having an absolute filtration accuracy of 2.5 μm to obtain a polymer solution.

### (Fabrication of Film)

The cellulose acylate solution was kept at 25° C., allowed to pass through a caster, Giesser (described in JP-A-11-314233), and cast onto a mirror-faced stainless support having a band length of 60 m and set to 10° C. A casting speed was set to 20 m/min, and a casting width was set to 200 cm. A space temperature in the entire casting zone was set to 10° C., and at points of from 25 to 40 m from the casting start zone, the cellulose acylate film was heated by a heater heated at 40° C. and disposed beneath the band. Then, at 50 cm before the end point of the casting zone, the cellulose acylate film thus cast and rolled was stripped off from the band, to which was then applied a drying air at 45° C. Subsequently, the resultant was dried at 110° C. for 5 minutes and then at 140° C. for 10 minutes, thereby obtaining a transparent film of the cellulose acylate having a film thickness of 80 μm. A residual amount of the solvent was 0.4% by mass.

### (Re-Stretching of Film)

After grasping the both ends of the above-fabricated cellulose acylate film with tenter clips, the film was stretched in the direction perpendicular to the conveyance direction in a heating zone set to 160° C. The obtained cellulose acylate film 201 had an Re of 143 nm, an Rth of −15 nm, a ΔRth of 20 nm, and a linear thermal expansion coefficient of 50 ppm/° C. Incidentally, these Re, Rth, ΔRth and linear thermal expansion coefficient were measured in the same manners as those in Example 1.

### <<Formation of Optically Active Layer>>

### <<Formation of Aligned Film>>

Subsequently, the surface of the cellulose acylate film 201 was subjected to a saponification treatment. The saponification treatment was carried out by dipping the film in a 2.0 N potassium hydroxide solution (25° C.) for 2 minutes, neutralizing with sulfuric acid, washing with pure water, and then drying. A surface energy of the thus saponified surface was determined by means of a contact method, and as a result, it was found to be 63 mN/m. On one surface of the saponified film, a coating liquid having the following composition was coated in a coating amount of 28 mL/m² by using a #16 wire bar coater.

[Composition of aligned film coating liquid]

| | | |
|---|---|---|
| Modified polyvinyl alcohol as described below: | 20 | parts by mass |
| Water: | 361 | parts by mass |
| Methanol: | 119 | parts by mass |
| Glutaraldehyde (crosslinking agent): | 0.5 | parts by mass |

Modified polyvinyl alcohol

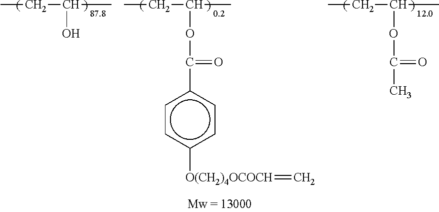

The coated composition was dried at 25° C. for 60 seconds and then dried with a warm air at 60° C. for 60 seconds and further with a warm air at 90° C. for 150 seconds. A thickness of the aligned film after drying was 1.1 μm. Also, a surface roughness of the aligned film was measured using an atomic force microscope (AFM) (SP1380N, manufactured by Seiko Instruments Inc.), and as a result, it was found to be 1.147 nm. The aligned film was subjected to a rubbing treatment in the same direction as a slow axis of the cellulose acylate film 201.

A coating liquid containing a discotic liquid crystal having the following composition was coated on the aligned film having been subjected to a rubbing treatment.

[Composition of coating liquid of discotic liquid crystal layer]

| | | |
|---|---|---|
| Discotic liquid crystalline compound (1) *1: | 32.6% | by mass |
| Cellulose acetate butyrate: | 0.7% | by mass |
| Ethylene oxide-modified trimethylolpropane triacrylate | 3.2% | by mass |
| (V#360, manufactured by Osaka Organic Chemical | | |
| Industry Ltd.): | | |
| Sensitizer (KAYACURE DETX, manufactured by | 0.4% | by mass |
| Nippon Kayaku Co., Ltd.): | | |
| Photopolymerization initiator (IRGACURE 907, | 1.1% | by mass |
| manufactured by Ciba-Geigy AG): | | |
| Methyl ethyl ketone: | 62.0 | by mass |

*1: 1,2,1′,2′,1″,2″-tris[4,5-di(vinylcarbonyloxybutoxybenzoyloxy)]phenylene (Illustrative Compound TE-8-(8) (m = 4) described in paragraph [0044] of JP-A-8-50206) was used as the discotic liquid crystalline compound (1).

Thereafter, the coated film was heated for drying in a drying zone at 130° C. for 2 hours, thereby aligning the discotic compound. Subsequently, the resulting film was irradiated with UV at 130° C. for 4 seconds by using a 120 W/cm high mercury pressure lamp, thereby polymerizing the discotic compound. Thereafter, the film was allowed to stand for cooling to room temperature, thereby forming an optically anisotropic layer having a thickness of 1.1 μm, exhibiting optically negative refractive index anisotropy and having a negative optical anisotropy of Re=0 nm and Rth=108 nm against visible light. The discotic liquid crystalline compound of the optical anisotropic layer was horizontally aligned within the range of ±2°.

There was thus fabricated an optical film 1201.

The Re and Rth of the whole of the film of the optical film 1201 at a wavelength of 550 nm at 25° C. and 60% RH were found to be 140 nm and 90 nm, respectively. The retardation values were measured using KOBRA 21ADH (manufactured by Oji Scientific Instruments).

### <Evaluation>

A pattern retardation plate used in a 3D monitor of a circular polarized glass system (manufactured by Zalman Tech Co., Ltd.) was stripped off, and the optical film 2101 was stuck thereto. At that time, the optical film 2101 was stuck such that its optically anisotropic layer was located on the polarizer side.

Similarly, a spectral radiance meter (SR-3, manufactured by Topcon Corporation) was placed at a position through the glasses, and a luminance was measured when the optical film 2101 was stuck. It was confirmed that the luminance was enhanced by 5% or more as compared with that in a configuration before stripping off the used pattern retardation plate.

Also, the crosstalk was evaluated in the same manner as that in Example 1. The evaluation results are shown in Table 14.

TABLE 14

| | At the initial stage | Low-humidity | High-temperature |
|---|---|---|---|
| | (25° C. and 60% | environment | environment |
| | RH) | (25° C. and 10% RH) | (45° C. and 60% RH) |
| Film | Crosstalk | | |
| 1201 | C | B | A |

### Example 3

### <Fabrication of Support (Cellulose Acetate Film 301)>

The following composition was charged into a mixing tank and stirred while heating to dissolve the respective components, thereby preparing a cellulose acetate solution.

[Composition of cellulose acetate solution]

| | |
|---|---|
| Cellulose acetate having a degree of acetylation of | 100 parts by mass |
| from 60.7 to 61.1%: | |
| Triphenyl phosphate (plasticizer): | 7.8 parts by mass |
| Biphenyl diphenyl phosphate (plasticizer): | 3.9 parts by mass |
| Methylene chloride (first solvent): | 336 parts by mass |
| Methanol (second solvent): | 29 parts by mass |
| 1-Butanol (third solvent): | 11 parts by mass |

In a separate mixing tank, 16 parts by mass of the following retardation raising agent (A), 92 parts by mass of methylene chloride, and 8 parts by mass of methanol were charged and stirred while heating, thereby preparing a retardation raising agent solution. 25 parts by mass of the retardation raising agent solution was mixed in 474 parts by mass of the cellulose acetate solution, and the mixture was thoroughly stirred to prepare a dope. An addition amount of the retardation raising agent was 6.0 parts by mass based on 100 parts by mass of the cellulose acetate.

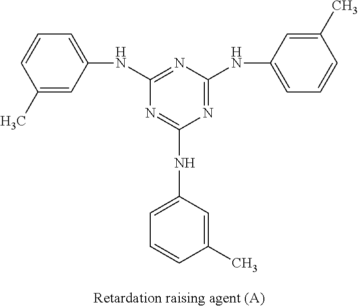

The obtained dope was cast using a band stretching machine. After the film surface temperature on the band reached 40° C., the cast dope was dried with a warm air at 70° C. for one minute, and the film was dried from the band with a dry air at 140° C. for 10 minutes, thereby fabricating a cellulose acetate film 301 having a residual amount of the solvent of 0.3% by mass.

The obtained longitudinal cellulose acetate film 301 had a width of 1,490 mm and a thickness of 80 μm. Also, it had an in-plane retardation (Re) of 8 nm and a retardation (Rth) in the thickness direction of 78 nm at 25° C. and 60% RH.

The fabricated cellulose acylate film 301 was measured in the same manners as those in Example 1 with regards to the ΔRth and linear thermal expansion coefficient. As a result, the ΔRth was 20 nm, and the linear thermal expansion coefficient was 50 ppm/° C.

### <<Formation of Optically Anisotropic Layer Containing Liquid Crystalline Compound>>

### (Alkali Saponification Treatment)

The cellulose acylate film 301 was allowed to pass through a dielectric heating roll at a temperature of 60° C.; after raising the film surface temperature to 40° C., an alkaline solution having the following composition was coated in a coating amount of 14 mL/m² on one surface of the film by using a bar coater; and the film was conveyed for 10 seconds beneath a steam type far infrared heater, manufactured by Noritake Co., Limited, which was heated at 110° C. Subsequently, 3 mL/m² of pure water was coated using the same bar coater. Subsequently, after repeating water washing by a fountain coater and water removal by an air knife three times, the film was conveyed into a drying zone at 70° C. for 10 seconds, thereby fabricating a cellulose acylate film having been an alkali saponification treatment.

### (Composition of Alkaline Solution)

[Composition of alkaline solution (parts by mass)]

| | |
|---|---|
| Potassium hydroxide: | 4.7 parts by mass |
| Water: | 15.8 parts by mass |
| Isopropanol: | 63.7 parts by mass |
| Surfactant (SF-1: C₁₄H₂₉O(CH₂CH₂O)₂OH): | 1.0 part by mass |
| Propylene glycol: | 14.8 parts by mass |

### (Formation of Aligned Film)

An aligned film coating liquid having the following composition was continuously coated on the above-saponified longitudinal cellulose acetate film by using a #14 wire bar. The coated film was dried with a war air at 60° C. for 60 seconds and further with a warm air at 100° C. for 120 seconds.

[Composition of aligned film coating liquid]

| | | |
|---|---|---|
| Modified polyvinyl alcohol as described below: | 10 | parts by mass |
| Water: | 371 | parts by mass |
| Methanol: | 119 | parts by mass |
| Glutaraldehyde (crosslinking agent): | 0.5 | parts by mass |
| Photopolymerization initiator (IRGACURE 2959, | 0.3 | parts by mass |
| manufactured by Ciba Japan K.K.): | | |

Modified polyvinyl alcohol

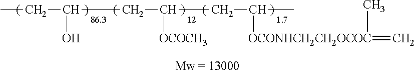

### (Formation of Optically Anisotropic Layer Containing Discotic Liquid Crystalline Compound)

The above-fabricated aligned film was continuously subjected to a rubbing treatment. At that time, the longitudinal direction and the conveyance direction of the longitudinal film were parallel to each other, and a rotation axis of a rubbing roller was inclined clockwise at 45° relative to the film longitudinal direction.

A coating liquid A containing a discotic liquid crystalline compound having the following composition was continuously coated on the above-fabricated aligned film by using a #2.7 wire bar. A conveyance speed (V) of the film was set to 36 m/min. For the purposes of drying the solvent of the coating liquid and aligning and aging the discotic liquid crystalline compound, the film was heated with a warm air at 80° C. for 90 seconds. Subsequently, the alignment of the liquid crystalline compound was fixed upon UV irradiation at 80° C., thereby forming an optically anisotropic layer. There was thus obtained an optical film 1301.

[Composition of optically anisotropic layer coating liquid (A)]

| | | |
|---|---|---|
| Discotic liquid crystalline compound (1) as | 100 | parts by mass |
| described below: | | |
| Photopolymerization initiator (IRGACURE 907, | 3 | parts by mass |
| manufactured by Ciba Japan K.K.): | | |
| Sensitizer (KAYACURE DETX, manufactured by | 1 | part by mass |
| Nippon Kayaku Co., Ltd.): | | |
| Pyridinium salt as described below: | 1 | part by mass |
| Fluorine based polymer (FP1) as described below: | 0.4 | parts by mass |
| Methyl ethyl ketone: | 252 | parts by mass |

Discotic liquid crystalline compound 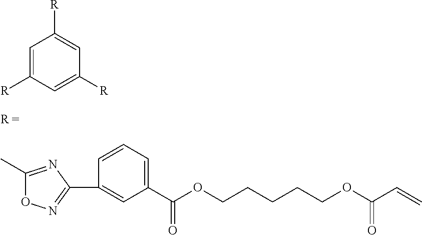
Pyridinium salt 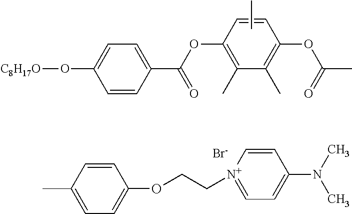
Fluorine based polymer (FP1)

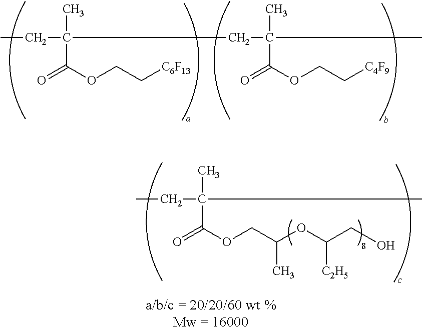

The direction of the slow axis of the optically anisotropic layer was parallel to the rotation axis of the rubbing roller. That is, the slow axis was inclined clockwise at 45° relative to the longitudinal direction of the support. Separately, instead of using the cellulose acetate film as the support, a layer containing a discotic liquid crystalline compound was formed using glass as a substrate, and it was inclined by an arbitrary axis and measured for Re. As a result, an average tilt angle of the disc surface of the discotic liquid crystalline molecule relative to the film surface was 90°, and it could be confirmed that the discotic liquid was aligned vertical against the film surface.

With regards to the retardation values, optical characteristics were measured using KOBRA 21ADH (manufactured by Oji Scientific Instruments). The mere optically anisotropic layer was measured at a wavelength of 550 nm at 25° C. and 60% RH, and as a result, it had an Re of 142 nm and an Rth of 77 nm. The Re and Rth of the whole of the film of the optical film 1301 at a wavelength of 550 nm at 25° C. and 60% RH were found to be 150 nm and 1 nm, respectively.

### (Mounting Evaluation on Liquid Crystal Display Device)

The fabricated optical film 1301 was mounted on a liquid crystal display device, thereby performing mounting evaluation. For a combination of the optical film 1301 with an optimal liquid crystal display device, it can be disposed as an application for viewing angle enlargement by disposing on the surface side of an upper polarizing plate of a 3D display, disposing on the 3D display side of a glass shutter of a 3D display system, or disposing between each of upper and lower polarizing plates and a liquid crystal cell of a 3D display.

### <Evaluation 1>

### <Evaluation>

A pattern retardation plate used in a 3D monitor of a circular polarized glass system (manufactured by Zalman Tech Co., Ltd.) was stripped off, and the optical film 3101 was stuck thereto. At that time, the optical film 3101 was stuck such that its optically anisotropic layer was located on the polarizer side.

Similarly, a spectral radiance meter (SR-3, manufactured by Topcon Corporation) was placed at a position through the glasses, and a luminance was measured when the optical film 3101 was stuck. It was confirmed that the luminance was enhanced by 5% or more as compared with that in a configuration before stripping off the used pattern retardation plate.

Also, the crosstalk was evaluated in the same manner as that in Example 1. The evaluation results are shown in Table 15.

TABLE 15

| | At the initial stage | Low-humidity | High-temperature |
|---|---|---|---|
| | (25° C. and 60% | environment | environment |
| | RH) | (25° C. and 10% RH) | (45° C. and 60% RH) |
| Film | Crosstalk | | |
| 1301 | A | B | A |

### <Evaluation 2>

### <<Fabrication of LCD-A>>

### (Configuration of Entire Solid of λ/4 Plate)

For a disposition method of the optical film 1301, a configuration analogous to that in FIG. 1 is preferable. In a 3D display, the optical film 1301 is disposed on the viewing side located outside of a polarizer (PVA) of a second polarizing plate, and a surface film having an antireflection or hard coat function is stacked thereon with a pressure-sensitive adhesive.

Specifically, the optical film 1301 was stuck on a frontal polarizing plate of a 3D monitor of a liquid crystal shutter glass system (manufactured by Olympus Visual Communications Corp). Also, the polarizing plate on the TV side used in the liquid crystal shutter glasses was stripped off.

Subsequently, a λ/4 plate was disposed vertical against a slow axis of the liquid crystal between the polarizing plate of the left eye/right eye side and the liquid crystal layer.

A spectral radiance meter (SR-3, manufactured by Topcon Corporation) was placed at a position through the glasses, and a luminance was measured when the polarizing plate was stuck. The luminance was enhanced by 5% or more as compared with that in a configuration before stripping off the polarizing plate.

### <Evaluation 3>

### <<Fabrication of LCD-C>>

### (Upper and Lower Configurations of VA Inner λ/4 Plate)

The optical film 1301 can also be used for improving a viewing angle upon being disposed between each of upper and lower polarizing plates and a liquid crystal cell. Here, a method of disposing the optical film 1301 on the upper and lower sides of a VA type liquid crystal cell is described.

The optical film 1301 was used as the optically anisotropic layer in Example 1 of JP-A-2005-062810. That is, an upper polarizing plate, a liquid crystal cell (an upper substrate, a liquid crystal layer and a lower substrate) and a lower polarizing plate were stacked from the observation direction (upper layer), and a backlight light source was further disposed. Also, the optical film 1301 for enhancing an optical performance of a liquid crystal display device was disposed between each of the polarizing plates and the liquid crystal cell. Here, an integrated polarizing plate obtained by integrating a protective film of a polarizing plate and an optically anisotropic layer was fabricated and then incorporated into a liquid crystal display device.

### <Fabrication of Liquid Crystal Cell>

The liquid crystal cell was fabricated according to the following procedures. An aligned film (for example, JALS204R, manufactured by JSR Corporation) was coated on the surface of a substrate and then subjected to a rubbing treatment, thereby regulating a director exhibiting an alignment direction of the liquid crystalline molecule, so-called tilt angle against the substrate surface to about 89°. A cell gap between the upper and lower substrates was set to 3.5 μm, and a liquid crystal having a negative dielectric anisotropy and having a An of 0.0813 and a Δε of about −4.6 (for example, Merck's MLC-6608) was added dropwise and injected between the upper and lower substrates, followed by sealing.

### <Measurement of Leakage Light of Fabricated Liquid Crystal Display Device>

A viewing angle dependency of transmittance of the thus fabricated liquid crystal display device was measured. An angle of elevation was measured from the front toward the oblique direction to 80° at intervals of 10°; and an azimuth was measured to 360° on the basis of the horizontal direction (0°) at intervals of 10°. It was noted that with regards to a luminance at the time of black display, a transmittance of leakage light increased with an increase of the angle of elevation from the front direction and took a maximum value in the neighbor at an angle of elevation of 60°. Also, it was noted that when a transmittance of black display increased, a contrast that is a ratio of a transmittance of white display and a transmittance of black display became worse. Then, the viewing angle characteristic was evaluated in terms of a transmittance of black display of the front and a maximum value of transmittance of leakage light at an angle of elevation of 60°.

In this Example, the front transmittance was 0.02%, the maximum value of leakage light transmittance at an angle of elevation of 60° was 0.04% at an azimuth of 30°. That is, a contrast ratio of the front was 500/1, and a contrast ratio at an angle of elevation of 60° was 250/1.

### <Evaluation 4>

### <<Fabrication of LCD-D>>

### <<Fabrication of ISP Mode Liquid Crystal Display Device>>

The optical film 1301 of the invention can also be used for improving a viewing angle upon being disposed between each of upper and lower polarizing plates and a liquid crystal cell in an IPS type liquid crystal display device.

### <Fabrication of Cellulose Acetate Film (T0)>

### (Preparation of Cellulose Acetate Solution)

The following composition was charged into a mixing tank and stirred while heating to dissolve the respective components, thereby preparing a cellulose acetate solution A.

[Composition of cellulose acetate solution A]

| | |
|---|---|
| Cellulose acetate having an acetyl substitution | 100.0 parts by mass |
| degree of 2.94: | |
| Methylene chloride (first solvent): | 402.0 parts by mass |
| Methanol (second solvent): | 60.0 parts by mass |

### (Preparation of Mat Agent Solution)

20 parts by mass of a silica particle having an average particle diameter of 16 nm (AEROSIL R972, manufactured by Nippon Aerosil Co., Ltd.) and 80 parts by mass of methanol were thoroughly stirred and mixed for 30 minutes to prepare a silica particle dispersion liquid. This dispersion liquid was charged together with the following composition into a dispersing machine and further stirred for 30 minutes or more to dissolve the respective components, thereby preparing a mat agent solution.

[Composition of mat agent solution]

| | |
|---|---|
| Silica particle dispersion liquid having an | 10.0 parts by mass |
| average particle diameter of 16 nm: | |
| Methylene chloride (first solvent): | 76.3 parts by mass |
| Methanol (second solvent): | 3.4 parts by mass |
| Cellulose acetate solution A: | 10.3 parts by mass |

### (Preparation of Additive Solution)

The following composition was charged into a mixing tank and stirred while heating to dissolve the respective components, thereby preparing a cellulose acetate solution.

[Composition of additive solution]

| | | |
|---|---|---|
| Optical anisotropy lowering agent as described below: | 49.3 | parts by mass |
| Wavelength dispersion adjusting agent as described | 4.9 | parts by mass |
| below: | | |
| Methylene chloride (first solvent): | 58.4 | parts by mass |
| Methanol (second solvent): | 8.7 | parts by mass |
| Cellulose acetate solution A: | 12.8 | parts by mass |

Optical anisotropy lowering agent 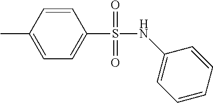
Wavelength dispersion adjusting agent

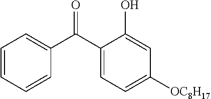

### (Fabrication of Cellulose Acetate Film)

94.6 parts by mass of the foregoing cellulose acetate solution A, 1.3 parts by mass of the foregoing mat agent solution and 4.1 parts of the foregoing additive solution were each filtered and mixed, and the mixture was cast using a band casting machine. In the foregoing composition, mass ratios of the optical anisotropy lowering agent and the wavelength dispersion adjusting agent were 12% and 1.2%, respectively relative to the cellulose acetate. The film was stripped from the band at a residual amount of the solvent of 30% and dried at 140° C. for 40 minutes, thereby manufacturing a longitudinal cellulose acetate film T0 having a thickness of 80 μm. The obtained film had an in-plane retardation (Re) of 1 nm (the slow axis was in a direction vertical to the film longitudinal direction) and a retardation (Rth) in the thickness direction of −1 nm.

### <Fabrication of Polarizing Plate P0>

A roll-shaped polyvinyl alcohol film having a thickness of 80 μm, which had been continuously dyed in an iodine aqueous solution, was stretched 5 times in the conveyance direction and dried to obtain a longitudinal polarizer. The foregoing cellulose acetate film T0 having been subjected to a saponification treatment was continuously stuck on one surface of this polarizer while sticking a commercially available cellulose acetate film (FUJITAC TD80UL, manufactured by Fujifilm Corporation) having been subjected to a saponification treatment on the other surface, thereby fabricating a polarizing plate (P0), by using a polyvinyl alcohol based adhesive.

Also, instead of the cellulose acetate film T0, the optical film 1301 was stuck such that its optically anisotropic layer was located on the polarizer side, thereby fabricating a polarizing plate (P1).

A liquid crystal cell having a configuration shown in FIG. 2 was fabricated. In FIG. 2, 100 is a liquid crystal device pixel region; 2 is a pixel electrode; 3 is a display electrode; 4 is a rubbing direction; each of 5a and 5b is a director of a liquid crystal compound at the time of black display; and each of 6a and 6b is a director of a liquid crystal compound at the time of white display. Specifically, on one glass substrate, electrodes were arranged such that a distance between the adjacent electrodes was 20 μm; a polyimide film was provided as a polyimide film thereon; and a rubbing treatment was carried out in the direction shown by the symbol 4 in FIG. 2. On one surface of a separately prepared glass substrate, a polyimide film was provided and subjected to a rubbing treatment to prepare an aligned film. The two glass substrates were superimposed while setting a cell gap (d) to 3.9 μm and stuck such that the aligned films were opposite to each other and that the rubbing directions of the two glass substrates were parallel to each other. Subsequently, a nematic liquid crystal composition having a refractive index anisotropy (Δn) of 0.0769 and a dielectric anisotropy (Δε) of positive 4.5 was enclosed to fabricate a horizontally aligned liquid crystal cell. A value of Δn·d of the liquid crystal layer was 300 nm.

The polarizing plates (P1 and P0) were stuck onto the upper and lower glass substrates of the foregoing horizontally aligned cell by using a pressure-sensitive adhesive. At that time, P1 was disposed in the polarizing plate on the backlight side, whereas P0 was disposed on the viewer's side; and the both were stuck in such a manner that the optically anisotropic layer contained in the polarizing plate (P1) came into contact with the glass substrate on the backlight side, whereas the cellulose acetate film (T0) contained in the polarizing plate (P0) came into contact with the glass substrate on the viewer's side. Also, the disposition was performed in such a manner that the absorption axis of the polarizing plate (P1) and the rubbing direction of the liquid crystal cell were orthogonal to each other and that the absorption axes of the polarizing plate (P1) and the polarizing plate (P0) were orthogonal to each other. There was thus fabricated a liquid crystal displace device L1.

The fabricated display device was impressed with a rectangular wave voltage of 55 Hz. A normally-black mode with a white display of 5 V and a black display of 0 V was employed. A display characteristic was evaluated using an analyzer (EZ-Contrast 160D, manufactured by ELDIM). As a result, a luminance at the time of black display was low, and a high contrast was obtained. Furthermore, when seen from an oblique direction, unevenness was a few.

### EXPLANATIONS OF LETTERS OR NUMERALS IN THE DRAWINGS

1: Liquid crystal display device

10: Light source

20: First polarizing plate

30: Liquid crystal cell

40: Second polarizing plate

60: Surface film

70L, 70R: Third polarizing plate

What is claimed is:

1. An optical film comprising: a transparent support satisfying the following expressions (1) and (2); and an optically anisotropic layer having a λ/4 function,
wherein
the optical film has an Rth (550) satisfying a relation of |Rth (550)|≦20:

|Re(550)|≦10 (1)

|ΔRth(25° C. 30% RH−25° C. 80% RH)|≦20 (2)
wherein
Re (550) represents an in-plane retardation Re at a wavelength of 550 nm, and Rth (550) represents a retardation Rth in a film thickness direction at a wavelength of 550 nm; and
ΔRth (25° C. 30% RH−25° C 80% RH) represents a difference between Rth (550) at 25° C. and 30% RH and Rth (550) at 25° C. and 80% RH,
wherein
the in-plane retardation Re and the retardation Rth in the film thickness direction are defined relative to a layer having a film thickness d according to the following expressions:
Re=(nx−ny)×d
Rth=((nx +ny)/2−nz)×d
wherein
nx represents a refractive index in a slow axis direction in a plane of the layer; ny represents a refractive index in ae direction orthogonal to nx in the plane; and nz represents a refractive index in the film thickness direction orthogonal to nx and ny.

2. The optical film according to claim 1, wherein the Rth (550) of the transparent support is smaller than 0.

3. The optical film according to claim 1, wherein the transparent support has a linear thermal expansion coefficient of 65 ppm/° C. or less.

4. The optical film according to claim 1, wherein the transparent support contains a cellulose acylate.

5. The optical film according to claim 4, wherein the cellulose acylate has an aromatic group-containing acyl group.

6. The optically film according to claim 4, wherein the transparent support contains a polymer plasticizer in a content of 30% by mass or more relative to the cellulose acylate, the polymer plasticizer having a number average molecular weight of from 500 to 10,000 and having a repeating unit including a dicarboxylic acid and a diol

7. A polarizing plate comprising: a polarizer, and a protective layer, wherein the protective film is an optical film according to claim 1.

8. The polarizing plate according to claim 7, wherein the optically anisotropic layer is a patterning retardation layer including a plurality of regions, wherein directions of slow axes of the regions are different from each other.

9. A liquid crystal display device comprising a polarizing plate according to claim 7.

10. A liquid crystal display device comprising:
a pair of substrates disposed opposing to each other, at least one of which has an electrode;
a liquid crystal layer between the pair of substrates; and
a first polarizing plate and a second polarizing plate interposing the liquid crystal sell, the first polarizing plate being disposed on a light source side, the second polarizing plate being disposed on a viewing side, each of the first and second polarizing plates having a polarizer and a protective film at least on an outer side surface of the polarizer,
with an image being viewed through a third polarizing plate existing on the viewing side of the second polarizing plate and having a polarizer and at least one protective film,
wherein
the protective film on the viewing side of the second polarizing plate is an optical film according to claim 1.
